(19) United States
(12) Patent Application Publication
(10) Pub. No.: US 2024/0022773 A1
(43) Pub. Date: Jan. 18, 2024

(54) MMT SIGNALING FOR STREAMING OF VISUAL VOLUMETRIC VIDEO-BASED AND GEOMETRY-BASED POINT CLOUD MEDIA

(71) Applicant: INTERDIGITAL PATENT HOLDINGS, INC., Wilmington, DE (US)

(72) Inventors: Ahmed Hamza, Coquitlam (CA); Srinivas Gudumasu, Montreal (CA)

(73) Assignee: INTERDIGITAL PATENT HOLDINGS, INC., Wilmington, DE (US)

(21) Appl. No.: 18/270,963

(22) PCT Filed: Jan. 5, 2022
(86) PCT No.: PCT/US2022/011298

§ 371 Date: Jul. 5, 2023

Related U.S. Application Data
(60) Provisional application No. 63/134,038, filed on Jan. 5, 2021.
(60) Provisional application No. 63/134,143, filed on Jan. 5, 2021.

(51) Int. Cl. H04N 21/236; H04N 19/136

(52) U.S. Cl. CPC H04N 21/236; H04N 19/136; H04N 19/597

(57) ABSTRACT

Methods, systems, and apparatuses for streaming of visual volumetric video-based coding (V3C) media and geometry-based point cloud coding (G-PCC) media are described herein. A method implemented in a receiving device may include receiving one or more of a first message including a list of media assets that are available to be streamed from the sending device, or one or more messages respectively describing the media assets. The method may further include sending a second message indicating a request for a subset of the media assets to be streamed from the sending device. The requested subset of the media assets may be determined based on a viewport of the receiving device. The method may further include receiving Motion Picture Experts Group (MPEG) Media Transport Protocol (MMTP) packets and processing the packets to recover at least a portion of the requested subset of the media assets.

### CROSS-REFERENCE TO RELATED APPLICATIONS

This application claims the benefit of U.S. Provisional Application No. 63/134,038 filed Jan. 5, 2021 and U.S. Provisional Application No. 63/134,143 filed Jan. 5, 2021; the contents of which are incorporated herein by reference.

### BACKGROUND

High-quality three-dimensional (3D) point clouds and other visual volumetric media, such as immersive video content in which a real or virtual 3D scene is captured by multiple real or virtual cameras, have recently emerged as advanced representations of immersive media.

Recent advances of technologies in capturing and rendering 3D points may allow for novel applications in the areas of tele-presence, virtual reality, and large-scale dynamic 3D maps. The 3D Graphics subgroup of ISO/IEC JTC1/SC29/WG11 Moving Picture Experts Group (MPEG) is currently working on the development of two 3D point cloud compression (PCC) standards: a geometry-based compression standard for static point clouds, and a video-based compression standard for dynamic point clouds. A goal of these standards may be to support efficient and interoperable storage and transmission of 3D point clouds. Among the requirements of these standards may be support for lossy and/or lossless coding of point cloud geometry coordinates and attributes. MPEG-I Visual is another MPEG subgroup working on the development of a standard for the compression of immersive video content to support 6DoF virtual walkthroughs with correct motion parallax within a bounded volume. Since both video-based point cloud compression and immersive videos with limited six degrees of freedom (6DoF) may rely on video-coded components, these coding of these two types of immersive media may be collectively referred to as visual volumetric video-based coding (V3C) and the same bitstream format may be used to represent their coded information.

### SUMMARY

Methods, systems, and apparatuses for streaming of visual volumetric video-based coding (V3C) media and geometry-based point cloud coding (G-PCC) media are described herein. A method implemented in a receiving device may include receiving one or more of a first message including a list of media assets that are available to be streamed from the sending device, or one or more messages respectively describing the media assets. The method may further include sending a second message indicating a request for a subset of the media assets to be streamed from the sending device. The requested subset of the media assets may be determined based on a viewport of the receiving device. The method may further include receiving Motion Picture Experts Group (MPEG) Media Transport Protocol (MMTP) packets and processing the packets to recover at least a portion of the requested subset of the media assets.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating one example of a video encoder;

FIG. 3 is a diagram illustrating one example of a video decoder;

FIG. 4 is a diagram illustrating an example of a system in which various aspects and embodiments described herein may be implemented;

FIG. 5 is a diagram showing an example of a system interface for a server and a client;

FIG. 6 is a diagram showing another example of a system interface for a server and a client;

FIG. 7 illustrates an example of the structure of a V3C bitstream;

FIG. 8 is a table illustrating examples of supported V3C attribute types;

FIG. 9 shows an example of the structure of a V3C container as may be implemented in accordance with ISOBMFF standards;

FIG. 10 illustrates an example of a multi-track container with more than one atlas and multiple atlas tiles;

FIG. 11 is a diagram illustrating one example of a structure of a bitstream;

FIG. 12 is a table providing an example syntax structure of a G-PCC TLV encapsulation unit;

FIG. 13 is a table providing possible values of a TLV type parameter and corresponding descriptions;

FIG. 14 is a table providing an example syntax structure of a G-PCC TLV unit payload;

FIG. 15 illustrates an example of a sample structure in accordance with schemes in which a bitstream providing G-PCC geometry and attribute information is stored in a single track;

FIG. 16 shows an example structure of a multi-track ISOBMFF G-PCC container;

FIG. 17 depicts an example end-to-end architecture of a system in which MMT signaling is carried out;

FIG. 18 is an illustration of a package structure according to some embodiments;

FIG. 19 is a table providing a list of defined application message types;

FIG. 20 is a table providing an example of a syntax structure of a V3C asset descriptor;

FIG. 21 is a table illustrating an example syntax of the V3CAssetGroupMessage;

FIG. 22 is a table illustrated an example of V3C data type values as may be used in a Data_type field;

FIG. 23 is a table illustrating an example syntax of the V3CSelectionMessage;

FIG. 24 is a table providing definitions of the switching_mode field;

FIG. 25 is a table illustrating an example syntax of the V3CViewChangeFeedbackMessage;

FIG. 26 is a table providing an example of a syntax structure of a G-PCC asset descriptor;

FIG. 27 is a table illustrating examples of defined G-PCC application message types;

FIG. 28 is a table illustrating an example syntax of a group message;

FIG. 29 is a table illustrating an example of G-PCC data type values as may be used in the Data_type field;

FIG. 30 is a table illustrating an example syntax of a GPCC selection feedback message;

FIG. 31 is a table providing definitions of the switching_mode field; and

FIG. 32 is a table illustrating an example syntax of a G-PCC view change feedback message (e.g., “GPCCViewChangeFeedback”);

### DETAILED DESCRIPTION

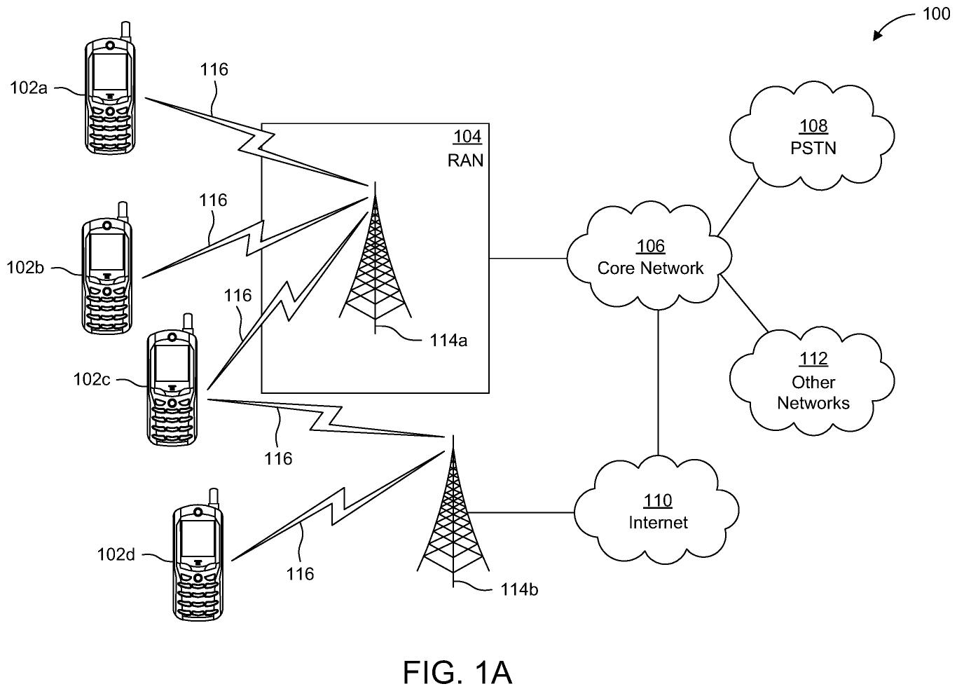

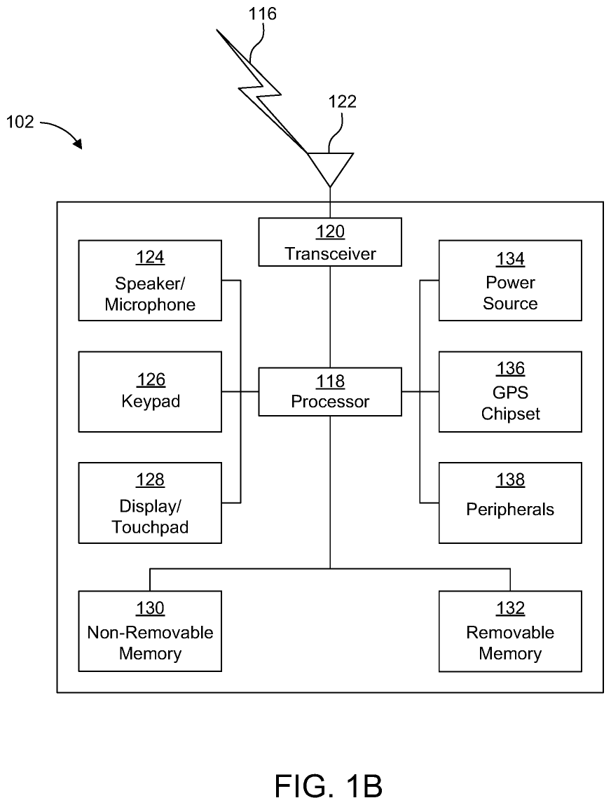

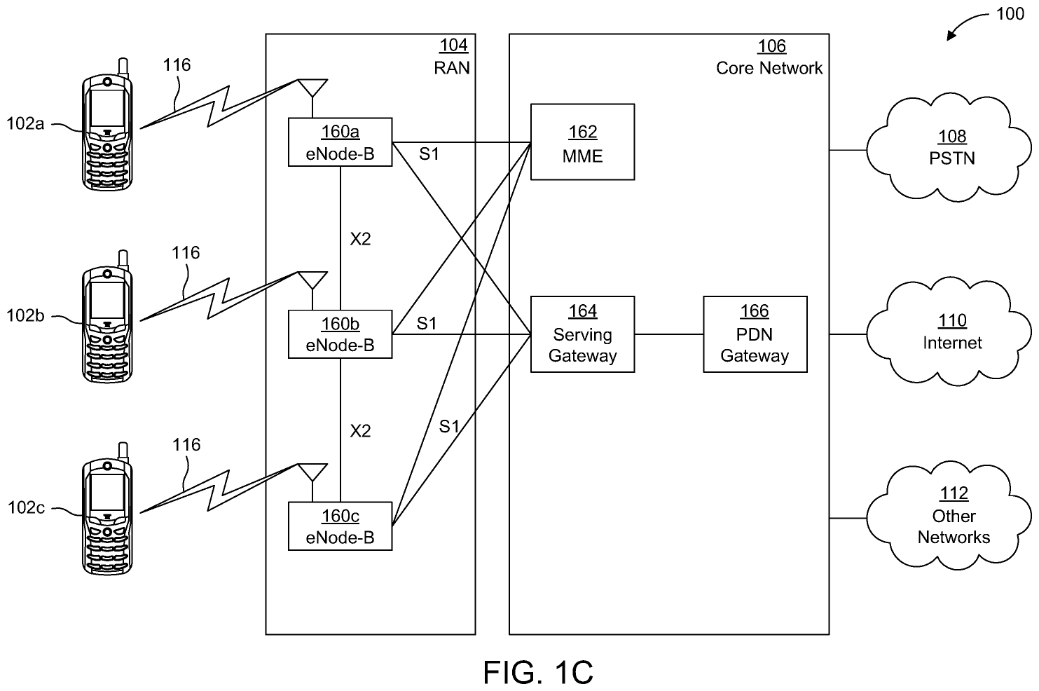

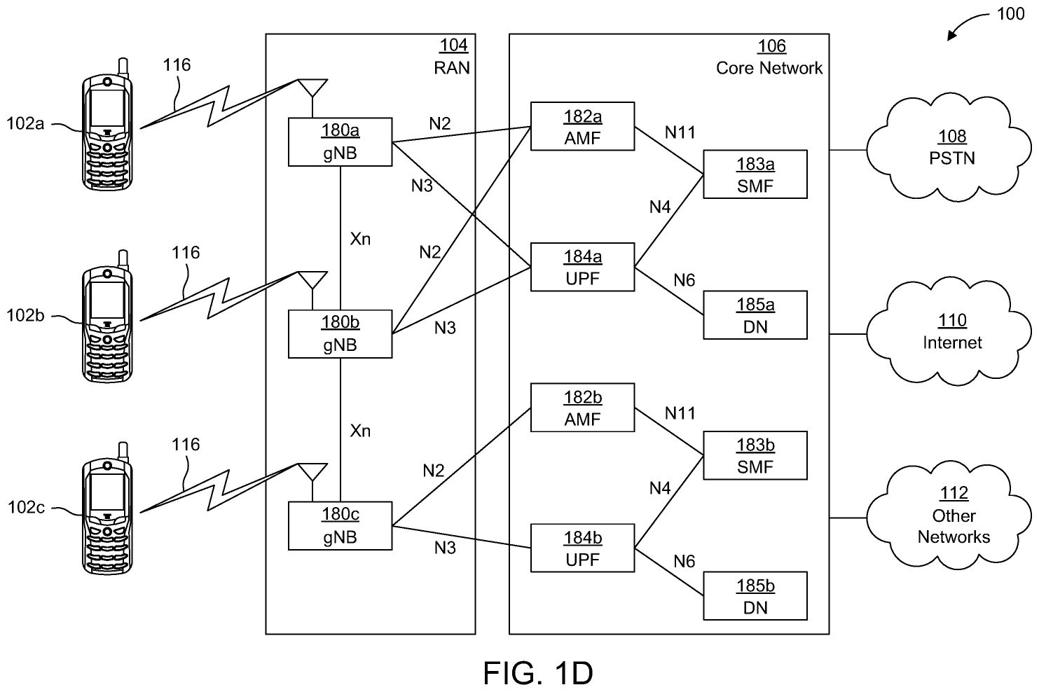

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102cand 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

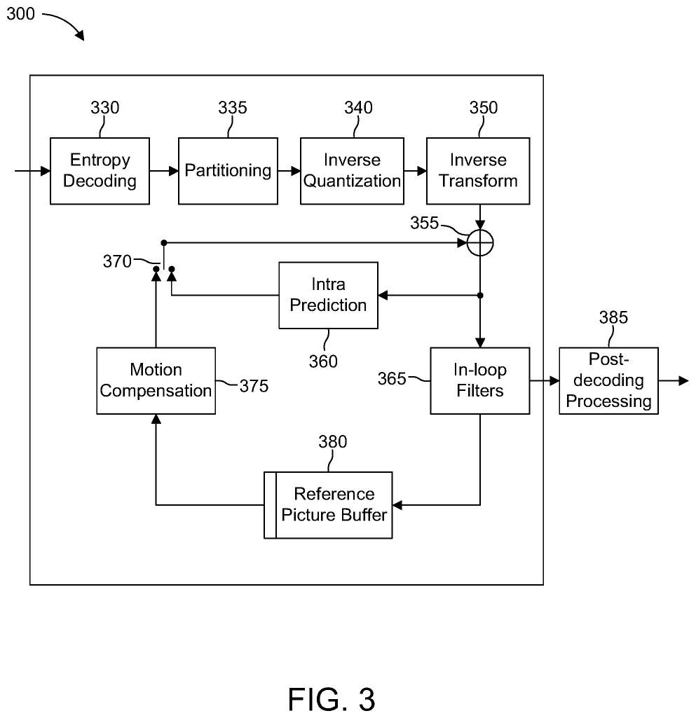

Various methods and other aspects described in this application may be used to modify modules, for example, of a video encoder 200 and decoder 300 as shown in FIG, 2 and FIG. 3. Moreover, the subject matter disclosed herein presents aspects that are not limited to V3C, G-PCC, and may be applied, for example, to any type, format or version of video coding, whether described in a standard or a recommendation, whether pre-existing or future-developed, and extensions of any such standards and recommendations (e.g., including V3C and G-PCC). Unless indicated otherwise, or technically precluded, the aspects described in this application may be used individually or in combination.

Various numeric values are used in examples described the present application, such as a number of bits reserved for fields of a V3C application message or a G-PCC application message. These and other specific values are for purposes of describing examples and the aspects described are not limited to these specific values.

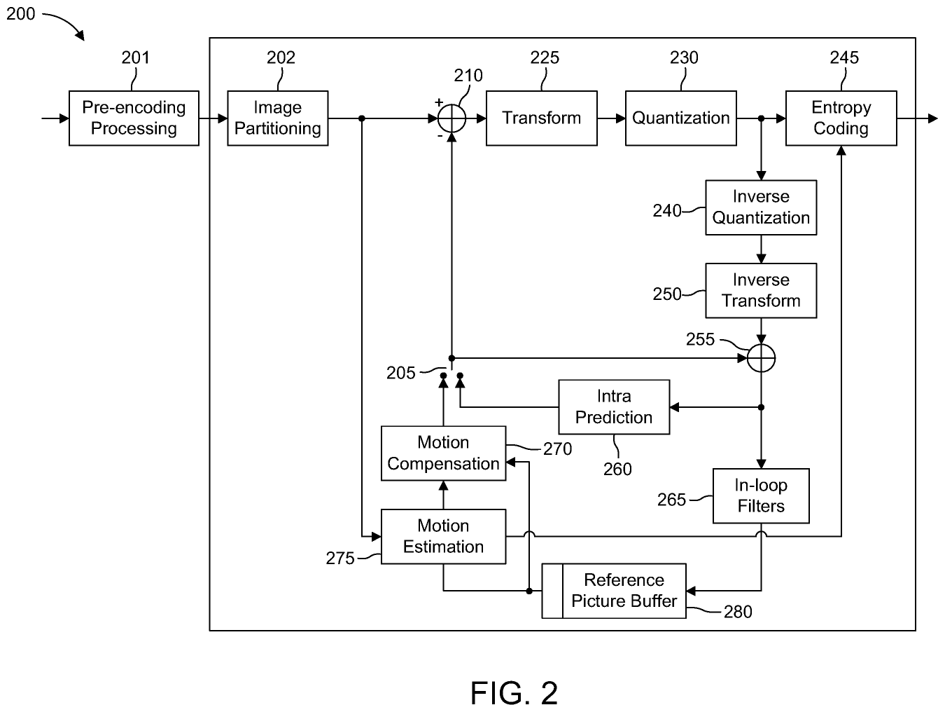

FIG. 2 is a diagram illustrating one example of the video encoder. Variations of an example encoder 200 are contemplated, but the encoder 200 is described below for purposes of clarity without describing all expected variations,

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and such metadata may be attached to the bitstream.

At the encoder 200, a picture may be encoded by the encoder elements as described below. The picture to be encoded may be partitioned (202) and processed in units of, for example, coding units (CUs). Each unit may be encoded using, for example, either an intra or inter mode. When a unit is encoded in an intra mode, it performs intra prediction (260), in an inter mode, motion estimation (275) and compensation (270) are performed. The encoder may decide (205) which one of the intra mode or inter mode to use for encoding the unit, and indicates the intra/inter decision by, for example, a prediction mode flag. Prediction residuals may be calculated, for example, by subtracting (210) the predicted block from the original image block.

The prediction residuals may then be transformed (225) and quantized (230). The quantized transform coefficients, as well as motion vectors and other syntax elements, may be entropy coded (245) to output a bitstream. The encoder may skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below, Video decoder 300 generally performs a decoding pass reciprocal to the encoding pass as described in FIG. 2, The encoder 200 also generally performs video decoding as part of encoding video data. In particular, the input of the decoder may include a video bitstream, which may be generated by video encoder 200, The bitstream may first be entropy decoded (330) to obtain transform coefficients, motion vectors, and other coded information. The picture partition information indicates how the picture is partitioned, the decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed, the predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4: :4) or an inverse remapping performing the inverse of the remapping process performed in the pre-encoding processing (201). The post-decoding processing may use metadata derived in the pre-encoding processing and signaled in the bitstream,

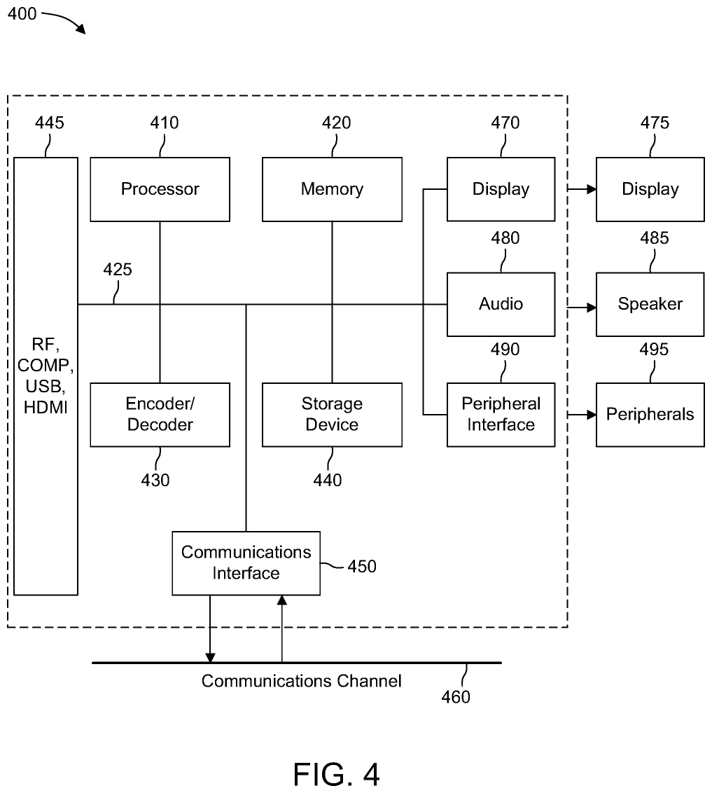

FIG. 4 is a diagram showing an example of a system in which various aspects and embodiments described herein may be implemented. System 400 may be embodied as a device including the various components described below and is configured to perform one or more of the aspects described in this document, Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IG), multiple ICs, and/or discrete components, For example, in at least one example, the processing and encoder/decoder elements of system 400 are distributed across multiple ICs and/or discrete components, in various embodiments, the system 400 is communicatively coupled to one or more other systems, or other electronic devices, via, for example, a communications bus or through dedicated input and/or output ports. In various embodiments, the system 400 is configured to implement one or more of the aspects described in this document,

The system 400 Includes at least one processor 410 configured to execute instructions loaded therein for implementing, for example, the various aspects described in this document, processor 410 may include embedded memory, input output Interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but. not limited to, Electrically Erasable Programmable Read-Only Memory (EEPROM). Read-Only Memory (ROM), Programmable Read-Only Memory (PROM), Random Access Memory (RAM), Dynamic Random-Access Memory (DRAM), Static Random-Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured to, for example, process data to provide an encoded video or decoded video, and the encoder/decoder module 430 may include its own processor and memory. The encoder/decoder module 430 represents module(s) that may be included in a device to perform the encoding and/or decoding functions, As is known, a device can include one or both of the encoding and decoding modules. Additionally, encoder/decoder module 430 may be implemented as a separate element of system 400 or may be Incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410, in accordance with various embodiments, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 410 and/or the encoder/decoder module 430 is used to store instructions and to provide working memory for processing that is needed during encoding or decoding. In other embodiments, however, a memory external to the processing device (for example. the processing device may be either the processor 410 or the encoder/decoder module 430) is used for one or more of these functions. The external memory may be the memory 420 and/or the storage device 440, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as, for example, MPEG-2. MPEG may refer to the Moving Picture Experts Group, and MPEG-2 may also be referred to as ISO/IEC 13818. ISO/IEC 13818-1 may also be known as H.222, and 13818-2 is also known as H.262), HEVG (HEVC refers to High Efficiency Video Coding, also known as H.265 and MPEG-H Part 2), or WC (Versatile Video Coding, a new standard being developed by JVET, the Joint Video Experts Team).

The input, to the elements of system 400 may be provided through various input devices as indicated in block 445. Such input devices include, but are not limited to, (I) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia interface (HDMI) input terminal. Other examples, not shown in FIG. 4, may include composite video.

In various embodiments, the input devices of block 445 may associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers, The RF portion may include a tuner that performs various of these functions, including, for example, down converting the received signal to a lower frequency (for example, an intermediate frequency or a near-baseband frequency) or to baseband, in one set-top box embodiment, the RF portion and its associated input processing element receives an RF signal transmitted over a wired (for example, cable) medium, and performs frequency selection by filtering, down converting, and filtering again to a desired frequency band. Various embodiments may rearrange the order of the above-described (and other) elements, remove some of these elements, and/or add other elements performing similar or different functions. Adding elements can include inserting elements in between existing elements, such as, for example. inserting amplifiers and an analog-to-digital converter, in various embodiments, the RF portion includes an antenna.

Additionally, the USB and/or HDMI terminals can include respective interface processors for connecting system 400 to other electronic devices across USB and/or HDMI connections, it is to be understood that various aspects of input processing, for example, Reed-Solomon error correction, may be implemented, for example, within a separate input processing 10 or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the data stream as necessary for presentation on an output device,

Various elements of system 400 may be provided within an integrated housing, Within the integrated housing, the various elements may be interconnected and transmit data therebetween using suitable connection arrangement 425, for example, an internal bus as known in the art, including the Inter-IC (I2C) bus, wiring, and printed circuit boards.

The system 400 includes communication interface 450 that enables communication with other devices via communication channel 460, The communication interface 450 can include, but is not limited to, a transceiver configured to transmit and to receive data over communication channel 460. The communication Interface 450 can include, but is not limited to, a modem or network card and the communication channel 460 may be implemented, for example, within a wired and/or a wireless medium.

Data may be streamed, or otherwise provided, to the system 400, in various embodiments, using a wireless network such as a Wi-Fi network, for example IEEE 802.11 (IEEE refers to the institute of Electrical and Electronics Engineers). The Wi-Fi signal of these examples is received over the communications channel 460 and the communications interface 450 which are adapted for Wi-Fi communications. The communications channel 460 of these embodiments is typically connected to an access point or router that provides access to external networks including the Internet for allowing streaming applications and other over-the-top communications. Other embodiments provide streamed data to the system 400 using a set-top box that delivers the data over the HDMI connection of the input block 445. Still other embodiments provide streamed data to the system 400 using the RF connection of the input block 445, As indicated above, various embodiments provide data in a non-streaming manner. Additionally, various embodiments may use wireless networks other than Wi-Fi, for example a cellular network or a Bluetooth network.

The system 400 may provide an output signal to various output devices, including a display 475, speakers 485, and other peripheral devices 495, The display 475 of various embodiments includes one or more of, for example, a touchscreen display, an organic light-emitting diode (OLED) display, a curved display, and/or a foldable display. The display 475 may be for a television, a tablet, a laptop, a cell phone (mobile phone), or other device, The display 475 can also be integrated with other components (for example, as in a smart phone), or separate (for example, an external monitor for a laptop), The other peripheral devices 495 include, in various examples of embodiments, one or more of a stand-alone digital video disc (or digital versatile disc) (DVR, for both terms), a disk player, a stereo system, and/or a lighting system. Various embodiments use one or more peripheral devices 495 that provide a function based on the output of the system 400, For example, a disk player performs the function of playing the output of the system 400.

In various embodiments, control signals may be communicated between the system 400 and the display 475, speakers 485, or other peripheral devices 495 using signaling such as AV Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450, The display 475 and speakers 485 may be integrated in a single unit with the other components of system 400 in an electronic device such as, for example, a television, in various embodiments, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various embodiments in which the display 475 and speakers 485 are external components, the output signal may be provided via dedicated output connections, including, for example, HDMI ports, USB ports, or COMP outputs.

The embodiments may be carried out by computer software implemented by the processor 410 or by hardware, or by a combination of hardware and software. As a non-limiting example, the embodiments may be implemented by one or more integrated circuits, The memory 420 may be of any type appropriate to the technical environment and may be implemented using any appropriate data storage technology, such as optical memory devices, magnetic memory devices, semiconductor-based memory devices, fixed memory, and removable memory, as non-limiting examples, The processor 410 may be of any type appropriate to the technical environment, and can encompass one or more of microprocessors, general purpose computers, special purpose computers, and processors based on a multi-core architecture, as non-limiting examples,

Various Implementations involve decoding. “Decoding”, as used in this application, may encompass all or part of the processes performed, for example, on a received encoded sequence in order to produce a final output suitable for display, in various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, decoding a portion of a coded point cloud sequence (e.g., encapsulated in an ISOBMFF container using one or more file format structures, for example, as disclosed herein) to provide partial access to the coded point cloud sequence (e.g., encapsulated in the ISOBMFF container), etc.

As further embodiments, in some examples “decoding” may refer only to entropy decoding, while in other embodiments “decoding” may refer only to differential decoding, and in other embodiments, “decoding” may refer to a combination of entropy decoding and differential decoding, Whether the phrase “decoding process” is intended to refer specifically to a subset of operations or generally to the broader decoding process will be clear based on the context of the specific descriptions and is believed to be well understood by those skilled in the art.

Various Implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, encoding a video-based point cloud bitstream comprising one or more file format structures (e.g., as disclosed herein) to provide partial access support to different parts of a coded point cloud sequence (e.g., encapsulated in an ISOBMFF container), etc.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

It should be noted that syntax elements as used herein, for example V3CSelectionMessage, V3CAssetGroupMessage, and V3CViewChangeFeedbackMessage, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device, Processors also include communication devices, such as, for example, computers, cell phones, portable/personal digital assistants (“PDAs”), and other devices that facilitate communication of information between end-users.

Reference to “one embodiment,” “an embodiment,” “an example,” “one implementation” or “an implementation,” as well as other variations thereof, means that a particular feature, structure, characteristic, and so forth described in connection with the embodiment is included in at least one embodiment, Thus, the appearances of the phrase “in one embodiment,” “in an embodiment,” “in an example,” “in one implementation,” or “in an implementation”, as well any other variations, appearing in various places throughout this application are not necessarily all referring to the same embodiment or example.

Additionally, this application may refer to “determining” various pieces of information, Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information, Accessing the information can include one or more of, for example, receiving the information, retrieving the information (for example, from memory), storing the information, moving the information, copying the information, calculating the Information, determining the information, predicting the information, or estimating the information.

Additionally, this application may refer to “receiving” various pieces of information. Receiving is, as with “accessing”, intended to be a broad term. Receiving the information can Include one or more of, for example, accessing the information, or retrieving the information (for example, from memory), Further, “receiving” is typically involved, in one way or another, during operations such as, for example, storing the information, processing the information, transmitting the information, moving the information, copying the information, erasing the information, calculating the information, determining the information, predicting the information, or estimating the information.

In is to be appreciated that the use of any of the following “and/or”, and “at least one of, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. In some embodiments, the encoder may signal (e.g., in an encoded bitstream and/or in an encapsulating file, such as an ISOBMFF container), for example, a parameter set, SEI messages, metadata, an edit list, post decoder requirements, signals that enable flexible partial access to different parts of the coded point cloud sequence encapsulated In an ISOBMFF container, a dependency list for each signaled object, a mapping to a spatial region, 3D bounding box information, etc. In this way, in an embodiment the same parameter is used at both the encoder side and the decoder side, Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various embodiments, it is to be appreciated that signaling may be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

Capturing and rendering three-dimensional (3D) images (e.g., using 3D point clouds) may have many applications such as tele-presence, virtual reality, and large-scale dynamic 3D maps. 3D point clouds may be used to represent immersive media, A 3D point cloud may Include a set of points represented in 3D space. A (e.g., each) point may include coordinates and/or one or more attributes. Coordinates may indicate the location of a {e.g., each) point. Attributes may include, for example, one or more of the following: a color associated with each point, transparency, time of acquisition, reflectance of laser or material property, etc. Point clouds may be captured or deployed in a number of ways, A point cloud may be captured or deployed, for example, using multiple cameras and depth sensors, Light Detection and Ranging (LIDAR.) laser scanners, and so on (e.g., to sample 3D space). A point (e.g., represented by coordinates and/or attributes) may be generated, for example, by sampling of an object in 3D space. Point clouds may comprise a plurality of points, each of which may be represented by a set of coordinates (e.g., x, y, z coordinates) that map to 3D space, in an example, a 3D object or scene may be represented or reconstructed with a point cloud comprising millions or billions of sampled points. 3D point clouds may represent static and/or dynamic (moving) 3D scenes.

Point cloud data may be represented and/or compressed (e.g., point cloud compression (PCC)), for example, to (e.g., efficiently) store and/or transmit point cloud data. Geometry-based compression may be utilized to encode and decode static point clouds and video-based compression may be utilized to encode and decode dynamic point clouds, for example, to support efficient and interoperable storage and transmission of 3D point clouds. Point cloud sampling, representation, compression, and/or rendering may support lossy and/or lossless coding (e.g., encoding or decoding) of a point cloud's geometric coordinates and/or attributes.

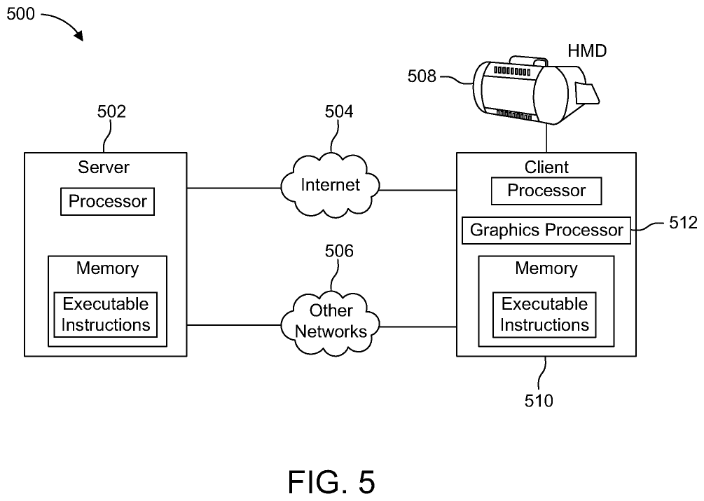

FIG. 5 is a diagram showing a system interface 500 for a server 502 and a client 510. The server 502 may be a point cloud server connected to the internet 504 and other networks 506. A client 510 may also be connected to the internet 504 and other networks 506, enabling communication between the nodes (e.g., server 502 and client 510). Each node may include a processor, a non-transitory computer readable memory storage medium, and executable instructions contained within the storage medium that are executable by the processor to carry out methods or portions of methods disclosed herein. One or more nodes may further include one or more sensors. The client 510 may (e.g., may also) include a graphics processor 512 for rendering 3D video for a display, such as a head-mounted display (HMD) 508. Any or all of the nodes may comprise a VVTRU and communicate over the networks, as described above with respect to FIGS. 1A-1D.

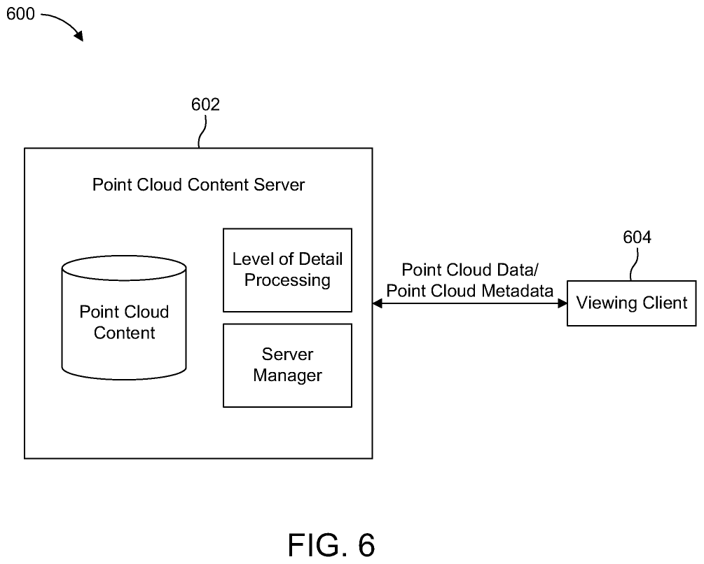

FIG. 6 is a diagram showing a system interface 600 for a server 602 and a client 604. The server 602 may be a point cloud content server 602 and may include a database of point cloud content, logic for processing the level of detail, and a server management function. In some examples, the processing for detail may reduce the resolution for transmission to a client 604 (e.g., viewing client 604). such as due to bandwidth limitations or as permitted because the viewing distance is sufficient to permit a reduction. The point cloud content server 602 may be in communication with the client 604, and point cloud data and/or point cloud metadata may be exchanged, For some examples, point cloud data rendered for a viewer may undergo a process of data construction to reduce and/or increase the level of detail, such as from point cloud data and/or point cloud metadata (e.g., streamed from the point cloud server 602 to the viewing client 604). The point cloud server 602 may stream the point cloud data in the resolution that the spatial capturing has provided, or, for some embodiments, down-sampled in order to comply with, e.g., bandwidth constraints or viewing distance tolerances. The point cloud server 602 may dynamically reduce the level of detail, in some examples, the point cloud server 602 may (e.g., may also) segment the point cloud data and identify objects within the point cloud. In some examples, points within point cloud data corresponding to a selected object may be replaced with lower resolution data.

A client 604 (e.g., a client 604 with an HMD) may request portions and/or tiles of a point cloud from the point cloud content server 602 via a bit stream, for example, a video-based point cloud compression (V-PCC) coded bitstream. For example, portions and/or tiles of a point cloud may be retrieved based on a location and/or an orientation of the HMD.

A point cloud may consist of a set of points represented in the 3D space using coordinates indicating the location of each point along with one or more attributes, such as the color associated with each point, transparency, time of acquisition, reflectance of laser or material property, etc. Point clouds may be captured in a number of ways. For example, one technique for capturing point clouds may involve using multiple cameras and depth sensors. Light Detection and Ranging (LiDAR) laser scanners may also be used for capturing point clouds. The number of points required in order to realistically reconstruct objects and scenes using point clouds may be in the order of millions (or even billions). Therefore, efficient representation and compression may be essential for storing and transmitting point cloud data. Similar to point clouds, some immersive video types may also be able to represent visual volumetric content and providing support for playback of a 3D scene within a limited range of viewing positions and orientations, with, for example, 6 Degrees of Freedom (6DoF).

As described substantially in paragraphs above, at least two 3D point cloud compression (PCC) standards are proposed: a geometry-based compression standard for static point clouds, and a video-based compression standard for dynamic point clouds. With respect to the video-based compression standard for dynamic point clouds, visual volumetric video-based coding (V3C) is one example, and various aspects of V3C-based implementations may be described as follows.

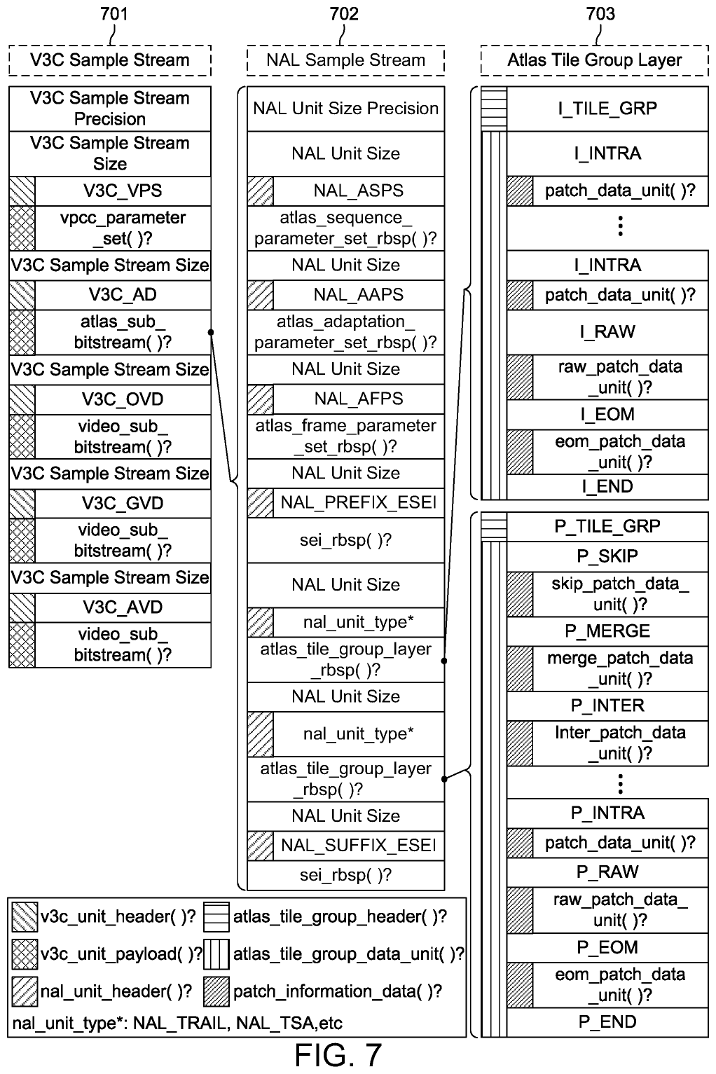

FIG. 7 illustrates an example of the structure of a V3C bitstream. As shown in FIG. 7, a bitstream may include a V3C sample stream 701, which may include of a set of V3C units, each having a V3C unit header and a V3C unit payload. The V3C unit header may describe the V3C unit type. For example, V3C unit types may include V3C_OVD, V3C_GVD, and/or V3C_AVD. V3C units with unit types V3C_OVD, V3C_GVD, and V3C_AVD, may be occupancy, geometry, and attribute video data units, respectively. These data units may represent the three main components needed for reconstructing the visual volumetric media content. The occupancy, geometry, and attribute V3C unit payloads may correspond to video data units (e.g., NAL units) that may be decoded by an appropriate video decoder. A V3C bitstream may also include one or more V3C_VPS units, which may provide a parameter set that defines syntax elements as may be used in V3C unit headers. A V3C bitstream may further include an atlas sub-bitstream (denoted, e.g., by the V3C unit header V3C_AD), which may carry a network abstraction layer (NAL) sample stream 702, including units including at least an NAL unit header and encapsulating data that defines (or partially defines) a coded atlas. For example, as shown in FIG. 7, an NAL unit may include, a payload of an atlas tile group layer 703 (e.g., a raw byte sequence payload (RBSP)) corresponding to an atlas tile group, which may include a header and data describing a patch (i.e., a region within the atlas that is associated with volumetric information).

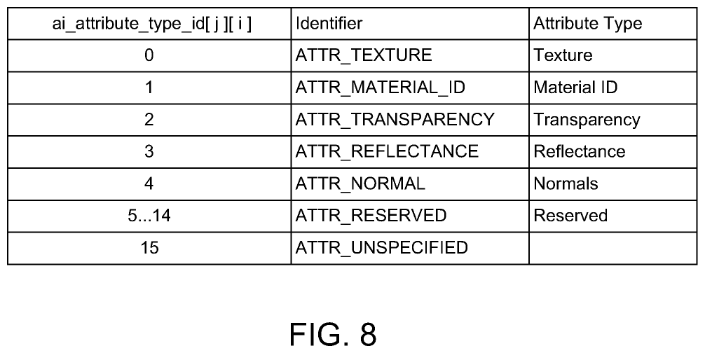

FIG. 8 is a table illustrating examples of supported V3C attribute types. In addition to the V3C unit type, the V3C attribute unit header may specify the attribute type. The V3C attribute unit header may also specify an index, allowing multiple instances of the same attribute type to be supported. For instance, supported attribute types may include texture, material, transparency, reflectance, or surface normal.

V3C container file formats are described herein.

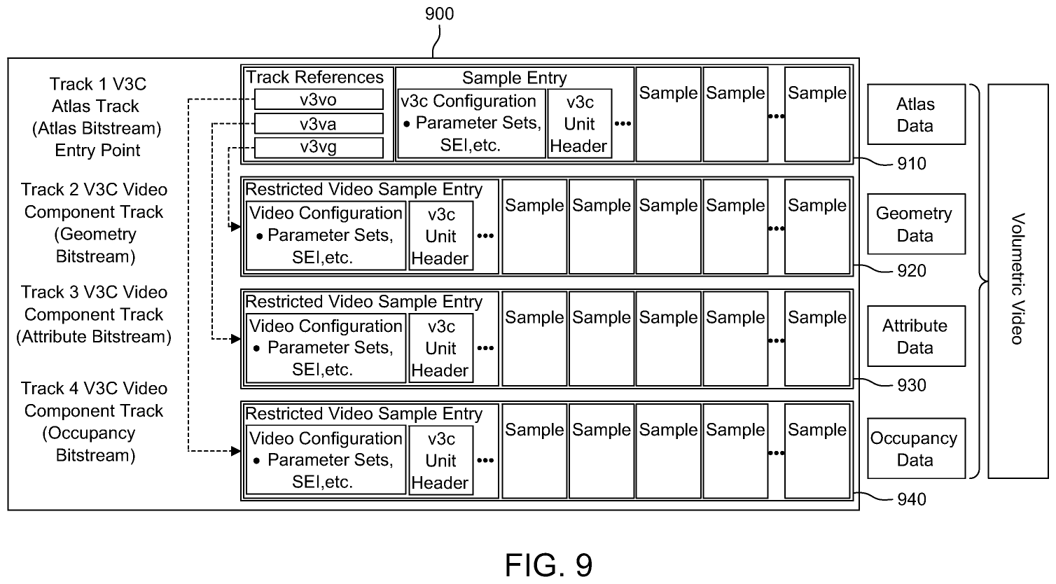

FIG. 9 shows an example of the structure of a V3C container as may be implemented in accordance with ISOBMFF standards. In general, a V3C container may contain volumetric video data 900, further defined by atlas data, geometry data, attribute data, and occupancy data. More specifically, a container may include a V3C atlas track 910 which contains a V3C parameter set and atlas parameter sets in the sample entry and atlas component bitstream NAL units in the samples. A V3C atlas track may also include track references to other tracks 920, 930, and 940, carrying the payloads of video compressed V3C units (i.e., V3C unit types equal to V3C_OVD, V3C_GVD, and V3C_AVD) or to V3C atlas tile tracks.

A container may include one or more V3C video component tracks where the samples contain access units of video-coded elementary streams for geometry data (i.e., payloads of V3C units of type equal to V3C_GVD), as is illustrated in FIG. 9 at 920. A container may include zero or more V3C video component tracks where the samples contain access units of video-coded elementary streams for attribute data (i.e., payloads of V3C units of type equal to V3C_AVD) as is illustrated in FIG. 9 at 930. A container may include zero or more V3C video component tracks where the samples contain access units of a video-coded elementary stream for occupancy data (i.e., payloads of V3C units of type equal to V3C_OVD), as is illustrated in FIG. 9 at 940.

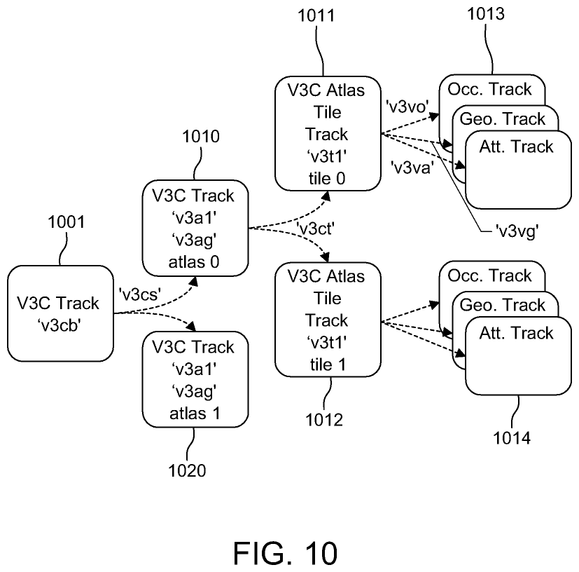

FIG. 10 illustrates an example of a multi-track container with more than one atlas and multiple atlas tiles. When multiple atlases are present in the V3C media, these atlases may be carried in separate atlas tracks with track references to associated V3C component tracks (i.e., tracks carrying associated occupancy map, geometry, and attribute information). If the atlas data contain two or more atlas tiles, these atlas tiles may be stored in separate atlas tile tracks that are referenced by the atlas track, with additional track references from the atlas tile tracks to tracks carrying associated V3C video component information for the atlas tiles carried by the atlas tile track. This may be demonstrated, for example, in FIG. 10. As illustrated at 1001, a V3C track ‘v3cb’ may include multiple atlases. The atlases may be stored in separate V3C tracks 1010 and 1020 with sample entries of ‘v3a1’ or ‘v3ag’, for example. The V3C tracks 1010 and 1020 may each include multiple atlas tile tracks 1011 and 1012, and each of the atlas tile tracks 1011 and 1012 may respectively include V3C component tracks 1013 and 1014.

As described substantially in paragraphs above, geometry-based compression (G-PCC) standards for static point clouds may also be defined to support efficient and interoperable storage and transmission of 3D point clouds. Methods, apparatuses, and systems that may be carried out and/or implemented in accordance with such geometry-based compression standards are proposed herein.

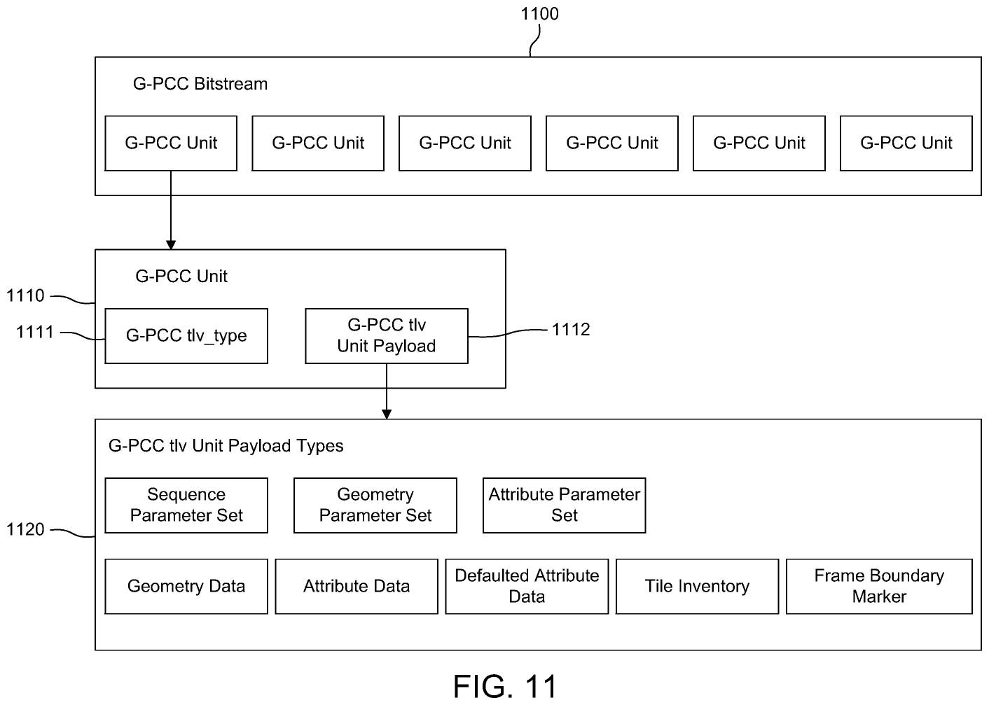

FIG. 11 is a diagram illustrating one example of a structure of a bitstream encoded in accordance with G-PCC standards. As shown in FIG. 11, a G-PCC bitstream 1100 may carry a set of G-PCC units, also known as type-length-value (TLV) encapsulation structures. As shown at 1110, a (i.e., each) G-PCC TLV unit may including information indicating a TLV type 1111 and a G-PCC TLV unit payload 1112. Though not depicted in FIG. 11, the GPCC TLV unit may further include information indicating a G-PCC TLV unit payload length, which may be expressed, for instance, in terms of bytes or bits. The G-PCC TLV unit payload 1112 may include information of a given type. For example, the G-PCC TLV unit payload may carry information of a given type, which may be, for example, a sequence parameter set, a geometry parameter set, a geometry data unit, an attribute parameter set, an attribute data unit, a tile inventory, a frame boundary marker, or a defaulted attribute data unit.

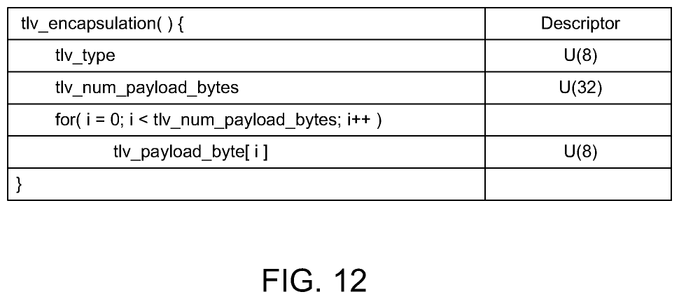

FIG. 12 is a table providing an example syntax structure of a G-PCC TLV encapsulation unit as may be defined according to, for instance, MPEG standards. As shown in FIG. 12, a TLV encapsulation unit may indicate a payload type using a first number of bits (or bytes), e.g., 8 bits. The TLV encapsulation unit payload length then may be expressed in a second number of bits (e.g., 32 bits). The G-PCC TLV encapsulation unit may include a payload having the indicated payload type and payload length.

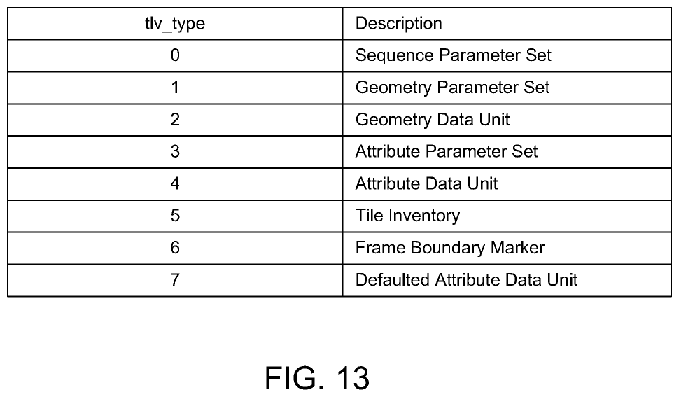

FIG. 13 is a table providing possible values of a TLV type parameter and corresponding descriptions of each of the possible values. As shown in FIG. 13, a TLV payload type may be a sequence parameter set, a geometry parameter set, a geometry data unit, an attribute parameter set, an attribute data unit, a tile inventory, a frame boundary marker, or a defaulted attribute data unit. G-PCC TLV units with unit types ‘2’ and ‘4’ may be geometry and attribute data units, respectively.

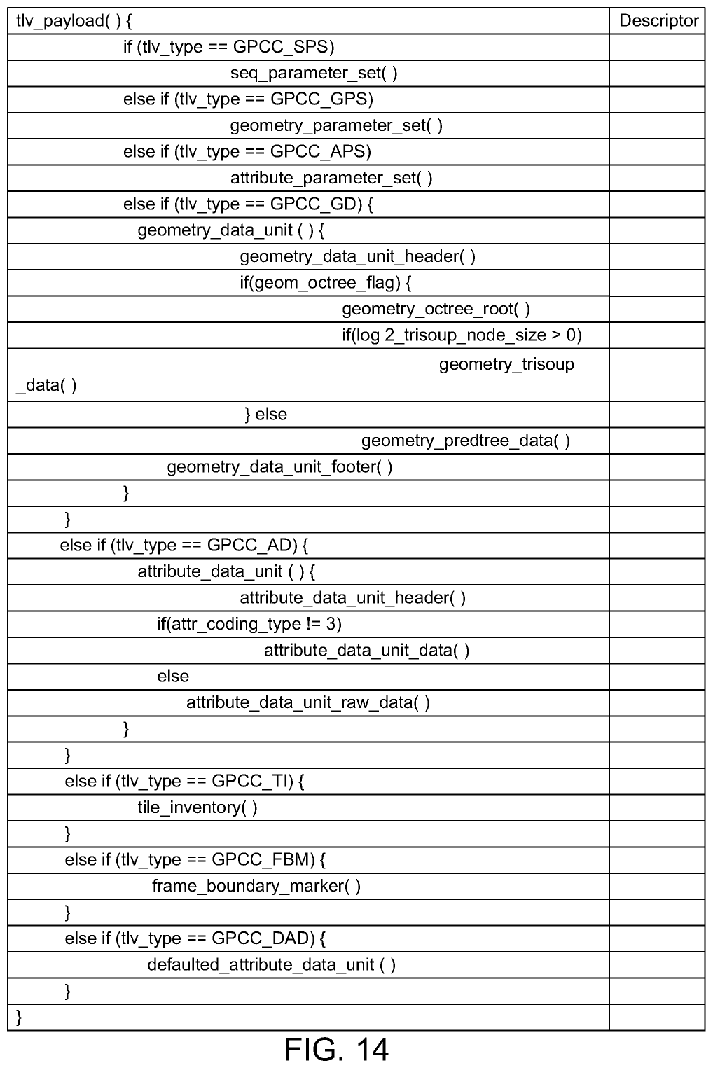

FIG. 14 is a table providing an example syntax structure of a G-PCC TLV unit payload. The example syntax shown in FIG. 14 may be consistent with, for example, a syntax structure as defined in MPEG-I Part 9 (ISO/IEC 23090-9). The payload information of geometry and attribute G-PCC units may correspond to media data units (e.g., TLV units) that may be decoded by a G-PCC decoder and that are specified in the corresponding geometry, and attribute parameter set G-PCC unit.

In some schemes, the G-PCC bitstream high-level syntax (HLS) may support the notion of slice and tile groups in geometry and attribute data. A frame may be partitioned into multiple tiles and slices. A slice may be understood as a set of points that can be encoded or decoded independently. A slice may include, for example, one geometry data unit and zero or more attribute data units. Information of an attribute data unit may depend upon the corresponding information of a geometry data unit within the same slice. Within a slice, the geometry data unit may necessarily appear before associated attribute units. The data units of a slice may be contiguous. The ordering of slices within a frame need not necessarily be specified.

In some schemes, a group of slices may be identified by a common tile identifier. Consistent with some standards, a tile inventory may be provided that describes a bounding box for each tile. A tile may overlap another tile in the bounding box. Each slice may contain an index that identifies the tile to which it belongs.

Described herein are G-PCC container file formats. When a G-PCC bitstream is carried in a single track, it may require the G-PCC encoded bitstream to be represented by a single-track declaration. Single-track encapsulation of G-PCC data may, in some cases, utilize the simple ISOBMFF encapsulation in which the G-PCC bitstream is stored in a single track without further processing. Each sample in such a track may contain one or more G-PCC components. In other words, each sample may include one or more TLV encapsulation structures.

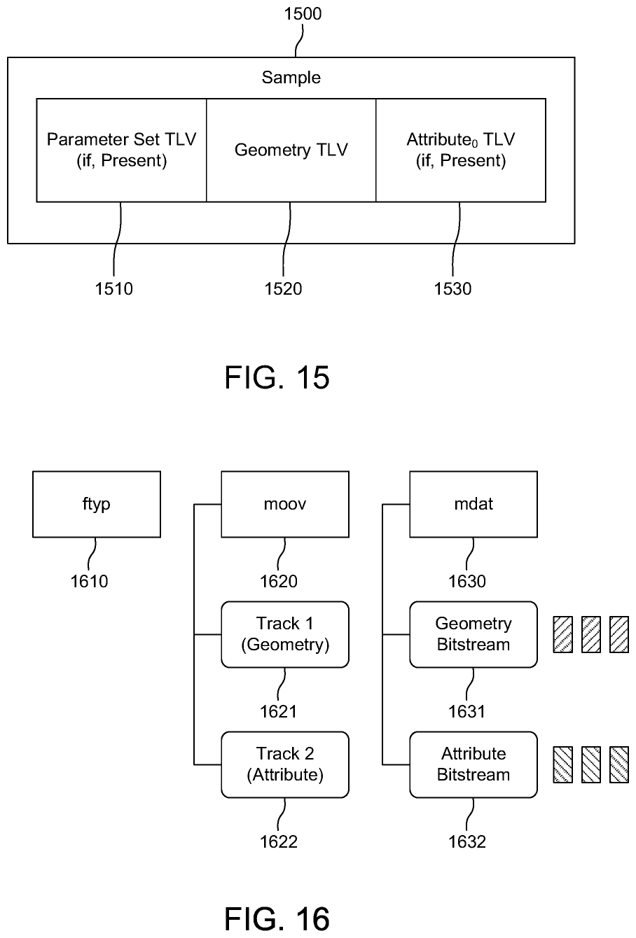

FIG. 15 illustrates an example of a sample structure in accordance with schemes in which a bitstream providing G-PCC geometry and attribute information is stored in a single track. As shown in FIG. 15, a sample 1500 of a track carrying a G-PCC bitstream may include at least one of a first TLV 1510 that provides a parameter set, a second TLV 1520 that provides geometry data, and a third TLV 1530 that provides attribute data corresponding to the geometry data of the second TLV 1520.

When a coded G-PCC geometry bitstream or bitstreams and a coded G-PCC attribute bitstream or bitstreams are stored in separate tracks, each sample in a track may contain at least one TLV encapsulation structure carrying a single G-PCC component data.

FIG. 16 shows an example structure of a multi-track ISOBMFF G-PCC container as may be implemented in accordance with some standards (such as MPEG-I Part 18 (ISO/IEC 23090-18)). A multi-track G-PCC container may include information units known as “boxes,” shown in FIG. 16 by the ftyp, moov, and mdat structures 1610, 1620, and 1630, respectively, which may be consistent with a base media file format defined in ISO/IEC 14496-12. The ftyp box 1610 may provide, for example, file type description information and common data structures used in the media file. The moov box 1620 and the mdat box 1630 may include a G-PCC tracks 1621 and 1631 that together contain a geometry parameter set, sequence parameter set and geometry bitstream samples carrying geometry data TLV units. the tracks may also include track references to other tracks carrying the payloads of G-PCC attribute component(s). the moov box 1620 and the mdat box 1630 may collectively include G-PCC tracks 1622 and 1632 which may contain the respective attribute's Attribute parameter set, and attribute bitstream samples carrying attribute data TLV units.

When a G-PCC bitstream is carried in multiple tracks, a track reference tool that may be implemented in accordance with some standards (such as ISO/IEC 14496-12) may be used to link G-PCC component tracks. In some instances, one or more TrackReferenceTypeBoxes may be added to a TrackReferenceBox within a TrackBox of the G-PCC track. The TrackReferenceTypeBox may contain an array of track_IDs designating the tracks that the G-PCC track references. To link the G-PCC geometry track to the G-PCC attribute track, a reference_type of a TrackReferenceTypeBox in the G-PCC geometry track may identify the associated attribute tracks. A four-character code (4CC) associated with these track reference types may be ‘gpca’, which may indicate that the referenced track(s) contain the coded bitstream of G-PCC attribute data

When a geometry stream of a G-PCC bitstream contains multiple tiles, each tile, or a group of tiles, may be encapsulated in a separate track, which may be referred to as a geometry tile track. The geometry tile track may carry TLV units of one or more geometry tiles, therefore enabling direct access to these tiles. Similarly, the attribute stream(s) of the G-PCC bitstream containing multiple tiles may also be carried in multiple attribute tile tracks.

Data of the G-PCC tile or tiles may be carried in separate geometry and attribute tile tracks of a container. To support partial access in ISOBMFF containers for G-PCC coded streams, tiles corresponding to a spatial region within the point cloud scene may be signaled in the samples of a timed metadata track, such as a track with a Dynamic3DSpatialRegionSampleEntry, which may be defined consistent with some MPEG standards, or in the GPCCSpatialRegionlnfoBox box as also may be defined in some MPEG standards. This may enable players and streaming clients to retrieve only the set of tile tracks carrying the information needed to render certain spatial regions or tiles within the point cloud scene.

A G-PCC base track may carry the TLV encapsulation structures containing only SPS, GPS, APS, and tile inventory information, consistent, for example, with ISO/IEC 23090-9. To link the G-PCC base track to the geometry tile tracks, a track reference with a new track reference type may be defined using the 4CC ‘gpbt’. Track references of the new type may be used to link the G-PCC base track with each of the geometry tile tracks.

Each geometry tile track may be linked with the other attribute or attributes of G-PCC tile tracks carrying attribute information of the respective tile or tile group using a track reference tool as may be implemented, for example, consistent with ISO/IEC 14496-12. The 4CCs of these track reference types may be, for example, ‘gpca’ as may be defined consistent with MPEG standards.

A point cloud scene may be coded in alternatives. In such a case, alternatives of coded G-PCC data may be indicated by an alternate track mechanism, as may be implemented consistent with ISO/IEC 14496-12. For example, an alternate_group field of the TrackHeaderBox may be used to indicate alternative of coded G-PCC data. When each alternative G-PCC bitstream is stored in a single track, G-PCC tracks containing the coded G-PCC bitstream, which may be alternatives of each other, may have the same alternate_group value in their TrackHeaderBox. When each alternative G-PCC bitstream is stored in a multi-track container, that is, a different component bitstream of each alternative G-PCC bitstream is carried in separate tracks, G-PCC geometry tracks of the alternative G-PCC bitstream may have the same alternate_group value in their TrackHeaderBox.

Methods, procedures, apparatuses, and systems for MPEG media transport (MMT) are described herein. Generally speaking, a set of tools may be used to enable advanced media transport and delivery services. The tools may be spread over three different functional areas: media processing unit (MPU) format, delivery, and signaling. Even though such tools may be designed to be efficiently used together, they may also be used independently.

The media processing unit (MPU) functional area may define the logical structure of media content, the package and the format of the data units to be processed by an MMT entity, and their instantiation with, for example, an ISO Base Media File Format. The package may specify the components comprising the media content and the relationship among them to provide necessary information for advanced delivery. The format of data may be defined to encapsulate the encoded media data for either storage or delivery and to allow for easy conversion between data to be stored and data to be delivered.

The delivery functional area may define an application layer transport protocol called the MMT Protocol (MMTP) and a payload format. An application layer transport protocol may provide enhanced features for delivery of multimedia data, such as multiplexing and support of mixed use of streaming and download delivery in a single packet flow. The payload format may enable carriage of encoded media data which may be agnostic to media types and encoding methods.

The signaling functional area may define formats of signaling messages to manage delivery and consumption of media data. Signaling messages for consumption management may be used to signal the structure of the package and signaling messages for delivery management may be used to signal the structure of the payload format and protocol configuration.

The MMT protocol may support the multiplexing of different media data such as Media Processing Units (MPUs) from various assets over a single MMTP packet flow. It may deliver multiple types of data in the order of consumption to the receiving entity to help synchronization between different types of media data without introducing a large delay or requiring a large buffer. MMTP may also supports the multiplexing of media data and signaling messages within a single packet flow.

In some embodiments, an MMTP payload may be carried in only one MMTP packet. Fragmentation and aggregation may be provided by the payload format and may not be provided by the MMTP itself. MMTP may define two packetization modes: Generic File Delivery (GFD) mode and MPU mode. The GFD mode may identify data units using their byte position inside a transport object. The MPU mode may identify data units using their role and media position inside an MPU. The MMT protocol may support mixed use of packets with two different modes in a single delivery session. A single packet flow of MMT packets may be arbitrarily composed of payloads with two types.

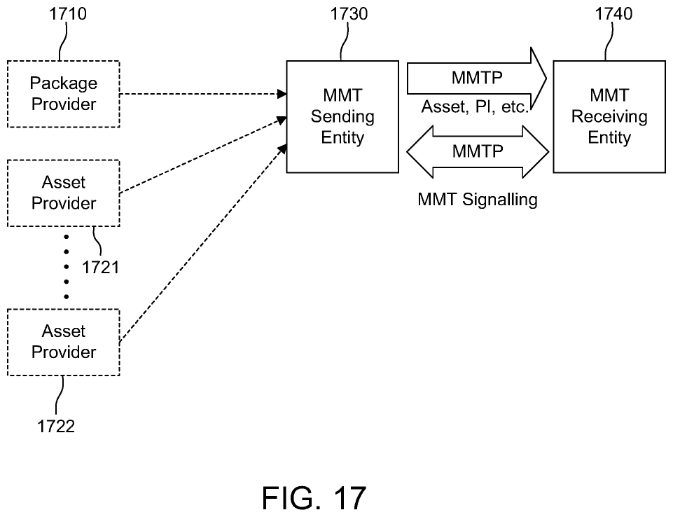

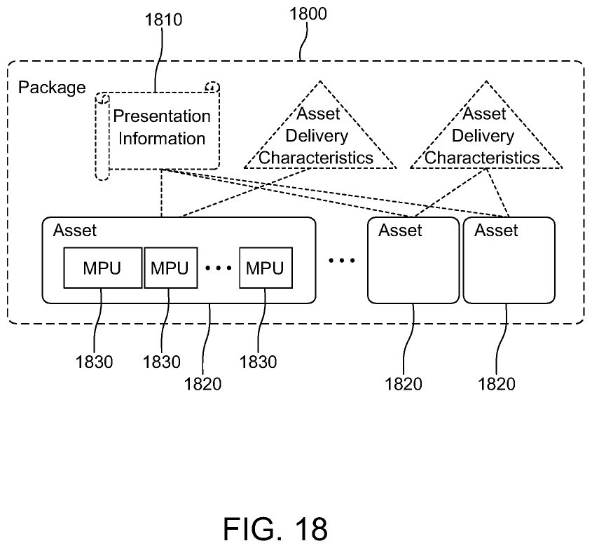

FIG. 17 depicts an example end-to-end architecture of a system in which MMT signaling is carried out. The architecture may at least include, but is not limited to, a package provider 1710, one or more asset providers 1721 and 1722, an MMT sending entity 1730, and an MMT receiving entity 1740. As shown in FIG. 17, the MMT sending entity 1730 may receive packages from the package provider 1710. The MMT sending entity 1730 may be responsible for sending the packages to the MMT receiving entity 1740 as MMTP packet flows. The MMT sending entity 1730 may be required to gather media contents from content providers based on the presentation information of the package that are provided by the package provider 1710. Media content may be provided as an asset that is segmented into a series of encapsulated MMT Processing Units that forms a MMTP packet flow. Hence, the MMT sending entity 1730 may gather assets information from one or more of the asset providers 1721 and/or 1722.

Signaling messages may be used to manage the delivery and the consumption of packages. The interfaces between the MMT sending entity 1730 and the MMT receiving entity 1740, as well as their operations, may be standardized. The MMT protocol (MMTP) may be used by the MMT receiving entity 1740 to receive and de-multiplex the streamed media based on the packet_id and the payload type. The de-capsulation procedure performed by the MMT receiving entity 1740 may depend on the type of payload that is carried and may be processed separately, for example, in the scenario depicted in FIG. 17.

Described herein are various aspects of an MMT data model. The MMT protocol may provide both streaming delivery and download delivery of coded media data. For streaming delivery, an MMT protocol may assume the specific data model including MPUs, assets and package. An MMT protocol may preserve the data model during the delivery by indicating the structural relationships among MPU, asset, and package using signaling messages.

The collection of the encoded media data and its related metadata may build a package. The package may be delivered from one or more MMT sending entities to one or more MMT receiving entities. One or more pieces of encoded media data of a package, such as a piece of audio or video content, may constitute an asset.

An asset may be associated with an identifier which may be agnostic to its actual physical location or service provider that is offering it, so that an asset can be globally uniquely identified. Assets with different identifiers may not be interchangeable. For example, two different Assets may carry two different encodings of the same content, but they may not be interchangeable. MMT may not specify a particular identification mechanism, but may allow for the usage of URIs or UUlDs for this purpose. Each asset may have its own timeline which may be of different duration than that of the whole presentation created by the Package.

Each MPU may constitute a non-overlapping piece of an asset—i.e. two consecutive MPUs of the same asset may not contain the same media samples. Each MPU may be consumed independently by the presentation engine of an MMT receiving entity.

FIG. 18 is an illustration of a package structure according to some embodiments. As shown in FIG. 18, a package 1800 may be a logical entity. A package 1800 may contain one or more presentation information documents 1810, one or more assets 1820, and for each asset, an associated asset delivery characteristics (ADC). Each of the assets 1820 may contain one or more MPUs 1830. Processing of a package may be performed on a per-MPU basis, and each MPU may share the same Asset ID.

MMT assets are further described herein according to some embodiments. An asset may be any multimedia data to be used for building a multimedia presentation. An asset may be a logical grouping of MPUs that share the same asset ID for carrying encoded media data. Encoded media data of an asset may be timed data or non-timed data. Timed data may include encoded media data that has an inherent timeline and may require synchronized decoding and presentation of the data units at a designated time. Non-timed data may include any other type of data that does not have an inherent timeline for decoding and presenting of its media content. The decoding time and the presentation time of each item of non-timed data may not necessarily be related to that of other items of the same non-timed data. For example, these may be determined by user interaction or presentation information.

Two MPUs of the same asset carrying timed media data may have no overlap in their presentation time. Any type of data which is referenced by the presentation information may be considered an asset. Examples of type of media data that may be considered individual assets may include audio data, video data, or web page data.

Features and characteristics of the media processing unit (MPU) are described herein. A media processing unit (MPU) may be a media data item that may be processed by an MMT entity and consumed by the presentation engine independently from other MPUs.

Processing of an MPU by an MMT entity may include encapsulation/de-capsulation and packetization/de-packetization. An MPU may include the MMT hint track indicating the boundaries of MFUs for media-aware packetization. Consumption of an MPU may include media processing (e.g., encoding/decoding) and presentation.

For packetization purposes, an MPU may be fragmented into data units that may be smaller than an Access Unit (AU). The syntax and semantics of MPU may not be dependent on the type of media data carried in the MPU. MPUs of a single asset may have either timed or non-timed media. An MPU may contain a portion of data formatted according to one or more of several standards, such as MPEG-4 AVC (ISO/IEC 14496-10) or MPEG-2 TS.

A single MPU may contain an integer number of AUs or non-timed data. For timed data, a single AU may not be fragmented into multiple MPUs. For non-timed data, a single MPU may contain one or more non-timed data items to be consumed by a presentation engine. An MPU may be identified by an associated asset identification (asset_id) and/or a sequence number.

Aspects of an MMTP payload are described herein. The MMTP payload may be a generic payload used to packetize and carry media data such as MPUs, generic objects, and other information for consumption of a package via the MMT protocol. The appropriate MMTP payload format may be used to packetize MPUs, generic objects, and signaling messages.

An MMTP payload may carry complete MPUs or fragments of MPUs, signaling messages, generic objects, repair symbols of AL-FEC schemes, or other data units or structures. A type of the payload may be indicated by a type field in the MMT protocol packet header. For each payload type, a one or more data units for delivery and, additionally or alternatively, a type specific payload header, may be defined. For example, a fragment of an MPU (e.g., an MFU) may be considered a single data unit when an MMTP payload carries MPU fragments. The MMT protocol may aggregate multiple data units with the same data type into a single MMTP payload. It may also fragment a single data unit into multiple MMTP packets.

An MFU may be a sample or subsample of timed data or an item of non-timed data. An MFU may contain media data that may be smaller than an AU for timed data and the contained media data may be processed by the media decoder. An MFU may contain an MFU header that contains information on the boundaries of the carried media data. An MFU may contain an identifier to uniquely distinguish the MFU inside an MPU. It may also provide dependency and priority information relative to other MFUs within the same MPU.

The MMTP payload may include a payload header and payload data. Some data types may allow for fragmentation and aggregation, in which case a single data unit may be split into multiple fragments or a set of data units may be delivered in a single MMTP packet.

There has been a substantial interest recently in new and emerging media types, such as virtual reality (VR) and immersive video and 3D graphics. High-quality 3D point clouds and immersive videos provide advanced representations of immersive media, enabling new forms of interaction and communication with virtual worlds. The large volume of information required to represent these new media types may require efficient coding algorithms. New standards for video-based point cloud compression are currently under development and will form the basis for visual volumetric video-based coding (V3C). Standards for geometry-based point cloud compression are also being developed and may define bitstreams for compressed static point clouds. In parallel, standards defining the carriage of V3C media and geometry-based point cloud data are also under development.

While discussions surrounding V3C carriage and point cloud standards may address the storage and signaling aspects of V3C data and point cloud data, such discussions may be limited, in that they may only concern, for example, signaling for dynamic adaptive streaming over HTTP based on the MPEG-DASH standard. Another important candidate standard for enabling different streaming and delivery applications is MPEG Media Transport (MMT). However, MMT standards may not currently provide any signaling mechanisms for V3C media. Therefore, new signaling elements that enable streaming clients to identify V3C streams and their component sub-streams are desired. In addition, it may also be necessary to signal different kinds of metadata associated with the V3C components to enable the streaming client to select the best version or versions of the V3C content or its components that it is able to support or that can be delivered given certain network constraints or the user's viewport at any given time.

Furthermore, it is envisioned that practical point cloud applications will require streaming point cloud data over the network. Such applications may perform either live or on-demand streaming of point cloud content depending on how the content was generated. Due to the large amount of information required for representing point clouds, such applications may need to support adaptive streaming techniques to avoid overloading the network and provide the optimal viewing experience at any given moment, e.g., with respect to the network capacity at that moment. Additionally, components of point cloud content may be divided into multiple tiles. One or more streaming clients may (e.g., only) want (e.g., determine or select) to stream a particular tile portion of the geometry components (e.g., instead of the whole point cloud data), for example, based on bandwidth availability. The G-PCC components tile data may be encapsulated into different G-PCC tile tracks. A (e.g., each) tile track may represent a set of G-PCC component tiles or a set of all the G-PCC component tiles.

Currently, MMT does not provide signaling mechanisms for point cloud media, including point cloud streams based on the MPEG G-PCC standard. Therefore, it is important to define new signaling elements that enable streaming clients to identify point cloud streams and their component sub-streams. It is also necessary to signal different kinds of metadata associated with the point cloud components to enable the streaming client to select the best version(s) of the point cloud or its components that it is able to support.

Solutions described herein may provide new signaling elements that enable MMT streaming clients to identify different components and metadata associated with V3C and GPCC media content and select the media data that a client needs to retrieve from the content server at any point in time during the streaming session. Additionally, solutions described herein may provide various methods for the encapsulation of G-PCC data for MMT streaming and the necessary MMT signaling messages for supporting the delivery of G-PCC data over MMT.

MMT delivery of V3C content is further described herein. V3C content may assist an MMT sending entity during the streaming process. For example, presentation information may contain information to describe MPUs that are conformant to V3C to enable appropriate processing by the application.

A player may receive information about a current viewing direction, a current viewport, and characteristics of the display for the device on which it is running. Based on this information, view-dependent streaming may be used to reduce the bandwidth needed in a streaming session. In the case of MMT, view-dependent streaming may be achieved by one or more approaches.

In some client-based streaming approaches, the MMT receiving entity may be instructed by the player to select a subset of the assets that carry V3C information needed for rendering parts of the V3C content that falls within (or intersects with) the current viewport. MMT session control procedures may be used to request the selected set of assets from the MMT sending entity. The player may use V3C application specific signaling messages from the server to select the appropriate assets to switch to for view-dependent streaming.

In some server-based approaches, the MMT receiving entity may rely on the MMT sending entity to select the correct subset of assets that provide V3C information for rendering parts of the V3C content that cover the current viewport. The receiving entity may use V3C application-specific signaling to send information about the current viewport to the sending entity.

Methods and procedures for mapping of V3C containers to MMT assets are described herein. To support the delivery of V3C content using MMT, each track inside a multi-track ISOBMFF V3C container may be encapsulated as a separate asset. The number of assets may therefore be equal to the number of tracks inside a container. Assets belonging to the same V3C component may be logically grouped into asset groups. These asset groups may be signaled to the receiving entity to enable a streaming client to make decisions on which asset groups to request. V3C application-specific MMT signaling is described herein.

For purposes of streaming V3C-encoded data using MMT, a number of V3C-specific MMT messages are defined. For example, V3C application-specific signaling may include the sending of: a group message, such as V3CAssetGroupMessage, a selection message such as V3CSelectionMessage, or a change view feedback message such as V3CViewChangeFeedbackMessage, In some embodiments, these messages may include an application identifier, for example, with a uniform resource name (URN) “urn:mpeg:mmt:app:v3c:2020” that may enable a sending entity to associate the signaling with a V3C application.

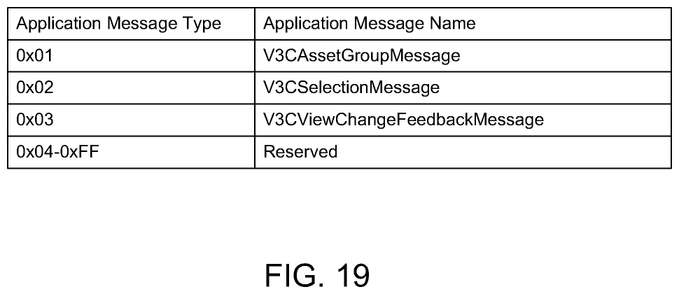

FIG. 19 is a table providing a list of defined application message types. In the proposed MMT V3C signaling, a set of application message types may be defined, and each message type of the set of may be associated with an application message name, as shown in FIG. 19. Through a V3CAssetGroupMessage, a sending entity may inform a client about a set of assets available at a server and provide a list of those assets that are being streamed to the receiving entity. In a V3CSelectionMessage, the client may request the set of assets to be streamed by the sending entity to the receiving entity. In a V3CViewChangeFeedbackMessage, the client may send an indication of the user's current viewing direction and viewport to the server in a server-based view-dependent streaming session.

When sending V3C content via MMT, in some embodiments, the V3CAssetGroupMessage may be mandatory and may provide the receiving entity with a list of assets available at the server that are associated with the V3C content. This message may also be used to inform the receiving entity about which of these assets are currently being streamed to the receiving entity. From this list, the client running on the receiving entity may request a unique sub-set of these V3C assets using the V3CSelectionMessage message.

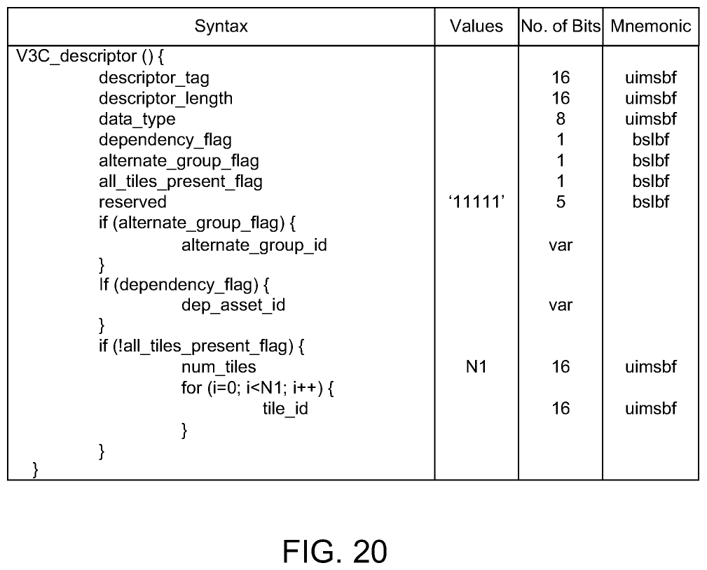

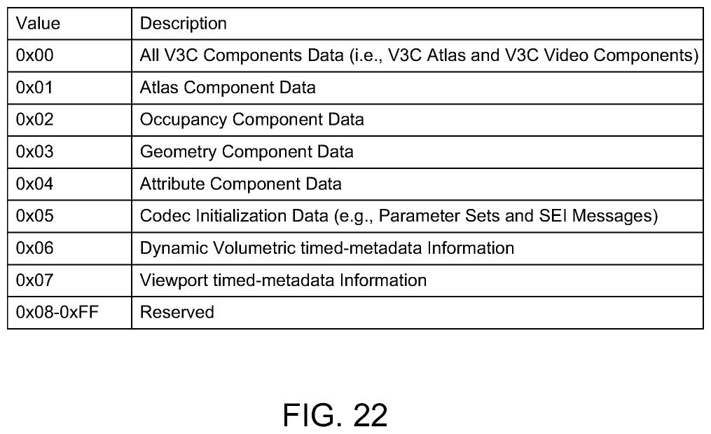

For view-dependent delivery of V3C content through MMT, the client may use the V3CViewChangeFeedbackMessage message to send its current viewport information to the server, after which the server may select and deliver the assets corresponding to that viewport to the client. The V3CAssetGroupMessage may also be used to update the client about the selected sub-set of assets. FIG. 20 is a table providing an example of a syntax structure of a V3C asset descriptor. The asset descriptor may be used to inform the receiving entity and the consuming application about the content of an asset that carries V3C content. Semantics of the V3C asset descriptor are provided herein. A descriptor tag, e.g., “Descriptor_tag”, may indicate the type of a descriptor. A descriptor length, e.g., “Descriptor_length”, may specify the length in bytes counting from the next byte after this field to the last byte of the descriptor. A data type, e.g., “Data_type” may indicate the type of V3C data present in this asset. Values for this field may be further illustrated in FIG. 22, introduced and described substantially in paragraphs below. A dependency flag, e.g., a “Dependency_flag” may indicate whether a V3C asset depends on data in another V3C asset for decoding. A value of zero may indicate this V3C component asset group data can be decoded independently. A Value of one may indicate this V3C asset depends on other V3C asset data for decoding. An alternate group flag, e.g., “Alternate_group_flag”, may indicate whether this V3C asset has an alternate version or not. A value of zero may indicate this V3C component asset does not have any alternate asset. A value of one may indicate this V3C asset has one or more alternates. An alternate group ID, e.g., “Alternate_group_id”, may indicate an ID that identifies a group of alternate assets. Different encoded versions of the same V3C asset may have the same value for this field. A dependent asset ID, e.g., “Dep_asset_id”, may indicate the value of the Asset ID on which decoding of this asset depends. In some cases, this value may be present only when the dependency_flag is set to 1. For example, V3C video component assets may use the corresponding V3C atlas component asset ID for this field. “Num_tiles” may indicate the number of tiles carried in this asset. “Tile_id”, may indicate a unique identifier for a particular atlas tile.

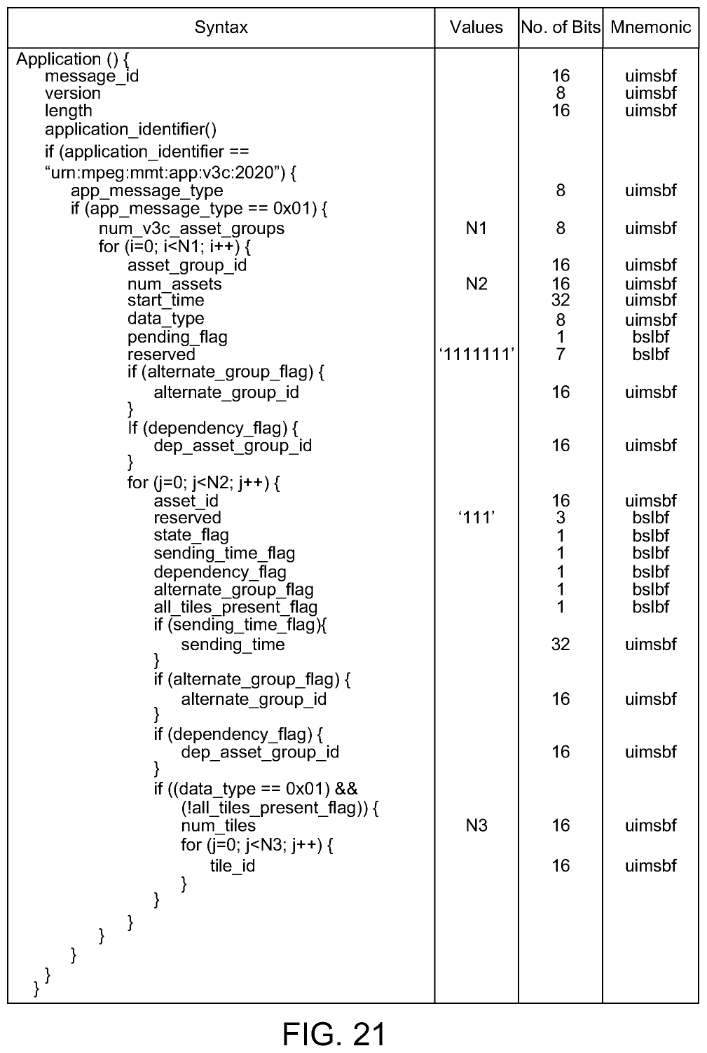

FIG. 21 is a table illustrating an example syntax of the V3CAssetGroupMessage. Consistent with the table of FIG. 21, the semantics of the V3CAssetGroupMessage may be described as follows. “Message_id” may indicate the identifier of the V3C application message. “Version” may indicate the version of the V3C application message. “Length” may indicate the length of the V3C application message in bytes, counting from the beginning of the next field to the last byte of the message. The value of this field may not be equal to zero. An application identifier, e.g., “Application_identifier”, may indicate the application identifier as a URN that uniquely identifies the application to consume the contents of this message. “App_message_type” may indicate an application-specific message type, as described substantially above with respect to FIG. 19. “Num_v3c_asset_groups” may indicate the number of V3C asset groups, where each group contains the assets associated with a V3C component. “Asset_group_id” may indicate the identifier of the asset group associated with a V3C component. “Num_assets” indicates the number of assets within an asset group which is associated with a V3C component. “Start_time” may indicate the presentation time of the V3C component from which the state of the assets listed in this message are applicable. “Data_type” may indicate the type of V3C data present in this asset group. Examples of values for this field may be described in the context of FIG. 22, introduced and described substantially in paragraphs that follow. “Pending_flag” may indicate whether all the data components are ready for rendering for an asset group. For example, when set to “1”, it may indicate that the data is ready, otherwise the flag may be “0”. “Asset_id” may provide the asset identifier of the asset. “State_flag” may indicate the delivery state of the asset. When set to one (“1”), this may indicate that the sending entity is actively sending the asset to the receiving entity. When set to zero (“0”), this may indicate that the sending entity is not actively sending the asset to the receiving entity. “Sending_time_flag” may indicate the presence of “sending_time” for the first MMTP packet containing the first MPU of the asset stream. The default value may be “0”. “Alternate_group_flag” may indicate whether this V3C component asset has an alternate version or not. A value of zero may indicate that this V3C asset does not have any alternate asset. A value of one may indicate that this V3C asset has an alternate asset. A dependency flag, e.g., “Dependency_flag”, may indicates whether this V3C component asset depends on data in other V3C assets for decoding. A value of zero may indicate this V3C component asset group data can be decoded independently. A value of one may indicate that this V3C asset depends on other V3C asset data for decoding. A sending time, e.g., “Sending_time”, may indicate the sending time for the first MMTP packet containing the first MPU of the asset stream. Using this information, the client may prepare a new packet processing pipeline for the new asset stream. “Alternate_group_id” may indicate an identifier of alternate V3C component assets. Different encoded versions of the same V3C asset may have the same value for this field. “Dep_asset_group_id” may indicate the ID for the asset on which the decoding of this asset is dependent. In some cases, this value may be present, for example, only when the dependency_flag is set to 1. For example, a V3C attribute component asset may use the corresponding V3C atlas component asset ID for this field. “All_tiles_present_flag” may indicate whether all tiles for the atlas component are part of an asset or not. A value of one may indicate that data for all the atlas tiles are available in the asset. A value of zero may indicate that data for a sub-set of the atlas tiles are available in the asset. “Num_tiles” may indicate the number of tiles carried in this asset. “Tile_id” may provide a unique identifier for a particular atlas tile.

FIG. 22 is a table illustrated an example of V3C data type values as may be used in the Data_type field. As shown in FIG. 22, the values for the Data_type field may indicate all V3C component data, atlas component data, occupancy component data, geometry component data, attribute component data, codec initialization data, dynamic volumetric timed-metadata information, or viewport-timed metadata information.

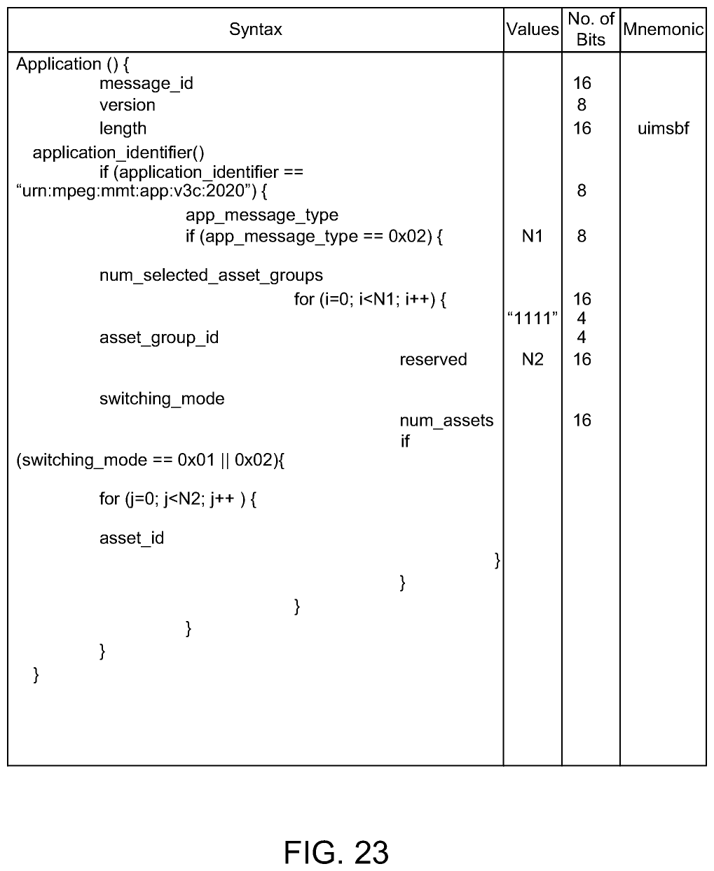

FIG. 23 is a table illustrating an example syntax of the V3CSelectionMessage. Consistent with the table of FIG. 23, the semantics of the V3CSelectionMessage may be described as follows. “Message_id” may indicate the identifier of the V3C application message. “Version” may indicate the version of the V3C application message. “Length” may indicate the length of the V3C application message in bytes, counting, for instance, from the beginning of the next field to the last byte of the message. The value of this field may not be equal to 0. “Application_identifier” may indicate the application identifier as a URN that uniquely identifies the application to consume the contents of this message. “App_message_type” may indicate an application-specific message type, as described substantially in paragraphs above with respect to FIG. 19. “Num_selected_asset_groups” may indicate the number of asset groups for which there is an associated state change request by the receiving entity. “Asset_group_id” may indicate the identifier of the asset group associated with a V3C content. “Switching_mode” may indicate the switching mode used for the selection of assets as requested by the receiving entity. A list of values for “switching_mode” may be defined, for example, consistent with paragraphs below introducing and describing FIG. 23. “Num_assets” may indicate the number of assets signaled for the state change according to the switching mode specified. “Asset_id” may indicate the identifier for the asset for the state change according to the switching mode specified.

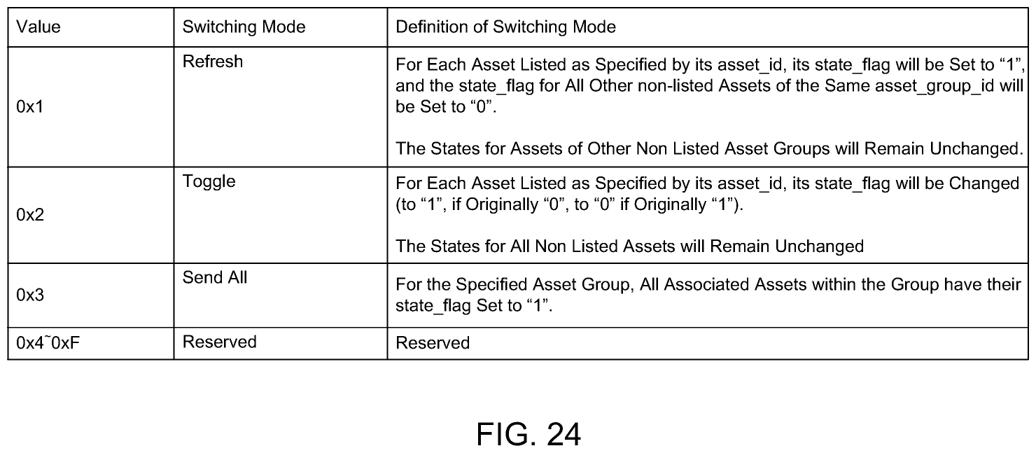

FIG. 24 is a table providing definitions of the switching_mode field. As shown in FIG. 24, the “switching_mode” field may indicate the switching mode used for the selection of assets. For example, if the switching mode is set to refresh, for each asset listed in the V3CSelectionMessage, the State_flag of each asset will be set to ‘1’ while the State_flag of all assets not listed in the V3CSelectionMessage will be set to ‘0’. If the switching mode is set to toggle, for each asset listed in the V3CSelectionMessage, the State_flag of each asset will be change, e.g., to ‘1’ if originally ‘0’, and to ‘0’ if originally ‘1’, while the State_flag of all assets not listed in the V3CSelectionMessage will not be changed. If the switching mode is set to send all, for all assets of an asset group specified in the V3CSelectionMessage, the State_flag of each asset will be set to ‘1’.

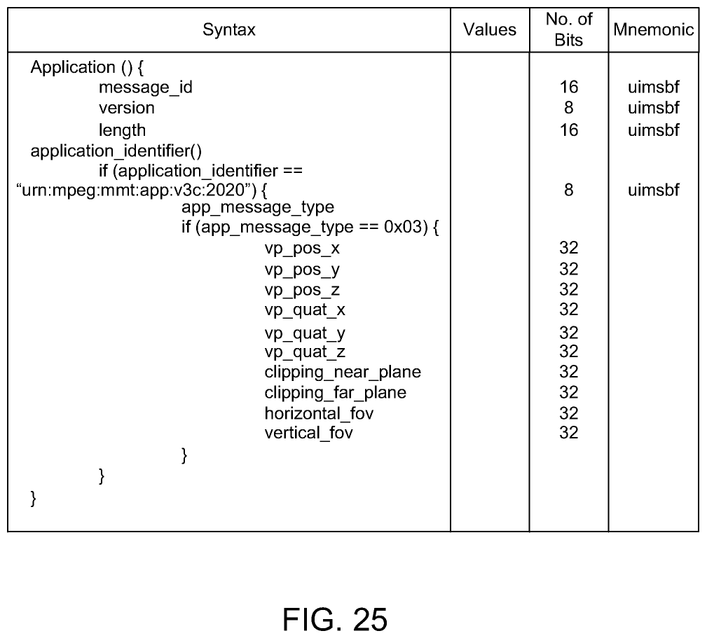

FIG. 25 is a table illustrating an example syntax of the V3CViewChangeFeedbackMessage. Consistent with the table of FIG. 25, the semantics of the V3CViewChangeFeedbackMessage may be described as follows. “Message_id” may indicate the identifier of the V3C application message. “Version” may indicate the version of the V3C application message. “Length” may indicate the length of the V3C application message in bytes, counting from the beginning of the next field to the last byte of the message. The value of this field shall not be equal to 0. “Application_identifier” may indicate the application identifier as a URN that uniquely identifies the application to consume the contents of this message. “App_message_type” may indicate an application-specific message type, as described substantially in paragraphs above with respect to FIG. 19. “Vp_pos_x”, “vp_pos_y”, and “vp_pos_z” may respectively indicate the x, y and z coordinates of the position of the viewport in meters in the global reference coordinate system. The values may be provided, for example, in units of 2⁻¹⁶ meters. “Vp_quat_x”, “vp_quat_y”, and “vp_quat_z” may indicate the x, y, and z components, respectively, of the rotation of the viewport region using the quaternion representation. The values may be floating-point values in the range of −1 to 1, inclusive. These values may specify the x, y and z components, namely qX, qY and qZ, for the rotations that are applied to convert the global coordinate axes to the local coordinate axes of the camera using the quaternion representation. The fourth component of the quaternion qW may be calculated in accordance with Eq. 1:

qW={square root over ((1−(qX²+qY²+qZ²)))} Equation (1)

The point (w, x, y, z) may represent a rotation around the axis directed by the vector (x, y, z) by an angle, which may be determined in accordance with Eq. 2

2*cos⁻¹(w)=2*sin⁻¹({square root over ((x²+y²+z²)).)} Equation (2)

“Clipping_near_plane” and “clipping_far_plane” may indicate the near and far depths (or distances) based on the near and far clipping planes of the viewport in meters. “Horizontal_fov” may specify the longitude range corresponding to the horizontal size of the viewport region, for example, in units of radians. The value may be in the range of 0 to 2πr. “Vertical_fov” may specify the latitude range corresponding to the vertical size of the viewport region, for example, in units of radians. The value may be in the range of 0 to π.

Methods and apparatuses relating to streaming client behavior are described herein. An MMT client may be guided by the information provided in the application-specific signaling messages. The following is an example of client behavior for streaming V3C content using the MMT signaling presented in this document.

In some methods, an MMT sending entity may send a “V3CAssetGroupMessage” application message to the interested clients. A receiving client may parse the “V3CAssetGroupMessage” application message and identify the V3C media assets present at the M MT content sending entity. To identify the available V3C media content, the streaming client may check for an “application_identifier” field in the “V3CAssetGroupMessage” application message set to “urn:mpeg:mmt:app:v3c:2020”. All or some of the V3C assets available in the V3C content may be identified by checking the asset IDs signaled in the “V3CAssetGroupMessage” application message. The client may choose the required assets to be streamed based on the user's current viewport. The MMT client may send a “V3CSelectionMessage” application message to the sending entity requesting the V3C assets it is interested in from the list of available V3C assets. The MMT sending entity may form the MMTP packets with MTPs and send the MTTP packets to clients.

In some methods, an MMT client may receive the MMTP packets and depacketize the MPUs or the MFUs. The MPUs/MFUs may contain the timed or non-timed V3C media content. When the MMT client receives the MMTP packets with an asset group “data_type” set to “0x05”, this V3C asset data represents the initialization information such as VPS, ASPS, AAPS, AFPS and SEI messages. When the MMT client receives the MMTP packets with an asset group “data_type” set to “0x06”, this V3C asset data may represent the 3D spatial regions timed-metadata information. The information in this asset may be used for partial access of the V3C content. When the MMT client receives the MMTP packets with an asset group “data_type” set to “0x07”, this V3C asset data may indicate initial or recommended viewport information. This information can used to enable automatic viewport changes based on different criteria. The MMT client may select the required V3C assets, for example, based on the user's viewport or a recommended viewport and the corresponding 3D spatial region or regions. The MMT client may send a “V3CSelectionMessage” application message to the sending entity requesting the V3C assets of interest.

In some methods, when the user's viewport changes in a client-based streaming approach, the MMT client may request a different set of V3C assets using the “V3CSelectionMessage” application message. When the user's viewport changes in a server-based streaming approach, the MMT client may send a “V3CViewChangeFeedbackMessage” message to the sending entity to signal the user's current viewport. Upon receiving this message, the MMT sending entity selects a new set of V3C assets based on the user's new viewport information and sends the “V3CAssetGroupMessage” application message to the MMT client with the corresponding V3C assets. The MMT sending entity may stream the V3C assets data as MMTP packets. The MMT client may start receiving the MMTP packets for all those requested V3C assets and extract the MPUs and MFUs from the MMTP payload. The MPUs and MFUs may contain the media samples directly or the media segments. The MMT client may start parsing the media segment container (e.g., ISOBMFF) to extract the elementary stream information and structure the V3C bitstream according to the V3C standard. The bitstream may be passed to the V3C decoder. When the MMTP payload contains the V3C media samples, elementary stream data is extracted and structured according to the V3C bitstream standard. The bitstream may be passed to the V3C decoder.

Embodiments directed to encapsulation and signalling of G-PCC data in MMT are described herein. Unlike traditional media content, G-PCC media content may include a number of components such as geometry and attributes. Each component may be separately encoded as a sub-stream of the G-PCC bitstream. Components, such as geometry and attributes may be encoded using a GPCC encoder. However, these sub-streams may need to be collectively decoded along with additional metadata in order to render a point cloud.

G-PCC encoded content may be delivered over networks using MMT. When the G-PCC components inside an ISOBMFF are signaled using multiple tracks, each track may be proposed to be encapsulated into a separate asset, which may then be packetized into MMTP packets in the usual manner. In order for the server and client to be able to identify a group of multiple assets to a certain G-PCC component, a G-PCC defined application message is also proposed.

G-PCC media content may include one or more (e.g., multiple) components, such as geometry and attributes. A (e.g., each) component may be (e.g., separately) encoded as a sub-stream of the G-PCC bitstream. Components, such as geometry and attributes, may be encoded using a GPCC encoder. Sub-streams may be collectively decoded along with additional metadata, e.g., in order to render a point cloud.

G-PCC data may be encapsulated and signaled in MMT. G-PCC encoded content may be delivered over networks using MMT. G-PCC data may be encapsulated for MMT streaming using a variety of encapsulation methods (e.g., as described herein). MMT signaling messages may (e.g., be generated and transmitted to) support the delivery of G-PCC data over MMT.

G-PCC components inside the ISOBMFF may be signaled using multiple tracks. A (e.g., each) track (e.g., among multiple tracks) may be encapsulated into a separate asset, which may (e.g., then) be packetized into MMTP packets. A G-PCC defined application message may (e.g., also) be configured/deployed, for example, for the server and client to identify a group of multiple assets to or for a certain G-PCC component.

In some examples (e.g., to support the delivery of G-PCC contents using MMT) a (e.g., each) track inside a multi-track ISOBMFF G-PCC container may be encapsulated into a separate asset. The number of assets may equal the number of tracks inside the multitrack ISOBMFF G-PCC container. In some examples, multiple assets that correspond to a (e.g., single) G-PCC component may be grouped and signaled as an asset group in a message (e.g., a “GPCCAssetGroupMessage” application message). Alternative component tracks may (e.g., also) be exposed in a message (e.g., using the “GPCCAssetGroupMessage” message), for example, to enable (e.g., efficient) server and client selection decisions (e.g., without first parsing the ISOBMFF file inside the MMTP packet).

MMT may define application-specific signaling messages, which may support (e.g., allow) the delivery of application-specific information. A G-PCC specific signalling message may be defined (e.g., configured) to stream G-PCC encoded data using MMT. A G-PCC specific signalling message may have an application identifier with a uniform resource name (URN) value (e.g., a URN value of “urn:mpeg:mmt:app:gpcc:2020”).

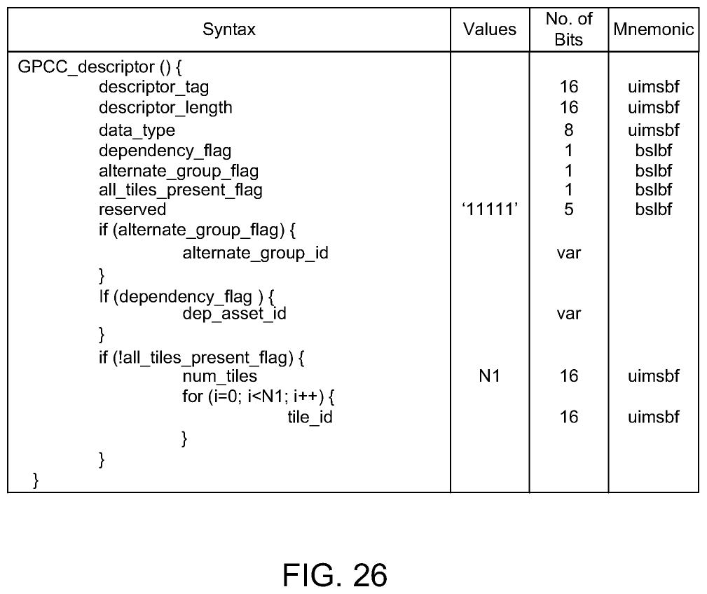

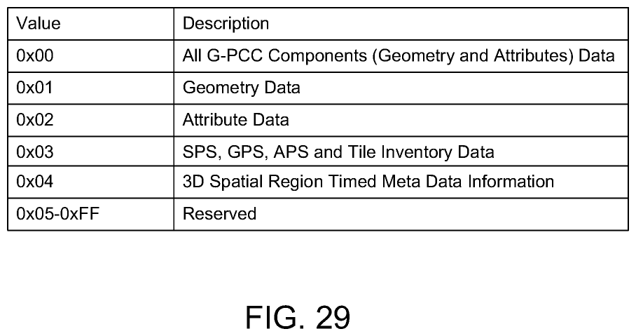

FIG. 26 is a table providing an example of a syntax structure of a G-PCC asset descriptor. The asset descriptor may be used to inform the receiving entity and the consuming application about the content of an asset that carries G-PCC content. Semantics of the G-PCC asset descriptor are provided herein. “Descriptor_tag” may indicate the type of a descriptor. “Descriptor_length” may specify the length in bytes counting from the next byte after this field to the last byte of the descriptor. “Data_type” may indicate the type of G-PCC data present in this asset. Values for this field may be further illustrated in FIG. 29, introduced and described substantially in paragraphs below. “Dependency_flag” may indicate whether a G-PCC asset depends on data in another G-PCC asset for decoding. A value of zero may indicate this G-PCC component asset group data can be decoded independently. A value of one may indicate this G-PCC asset depends on other G-PCC asset data for decoding. “Alternate_group_flag” may indicate whether this G-PCC asset has an alternate version or not. A value of zero may indicate this G-PCC component asset does not have any alternate asset. A value of one may indicate this G-PCC asset has one or more alternates. “Alternate_group_id” may indicate an ID that identifies a group of alternate assets. Different encoded versions of the same G-PCC asset may have the same value for this field. “Dep_asset_id” may indicate the value of the Asset ID on which decoding of this asset depends. In some cases, this value may be present only when the dependency_flag is set to 1. For example, G-PCC attribute component assets may use the corresponding G-PCC geometry component asset ID for this field. “Num_tiles” may indicate the number of tiles carried in this asset. “Tile_id” indicates a unique identifier for a particular tile in the tile inventory. When dynamic_tile_flag is set to value 0, tile_id may represent one of the tile id values present in the tile inventory.

MMT G-PCC signaling may include, for example, one or more of the following sets of (e.g., defined) application message types: a group message, such as GPCCAssetGroupMessage, a selection feedback message, such as GPCCSelectionMessageFeedback, and/or a change view feedback message, such as GPCCViewChangeFeedback.

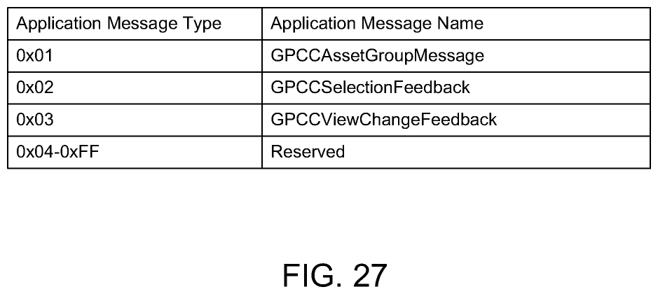

FIG. 27 is a table illustrating examples of defined G-PCC application message types. As shown in FIG. 27, the application message type may indicate that the message is a GPCCAssetGroupMessage, a GPCCSelectionMessageFeedback message, or a GPCCViewChangeFeedback message. In an example of a GPCCAssetGroupMessage message type, the sending entity may send a group message (e.g., GPCCAssetGroupMessage message) to inform the client about the set of assets available at the server, and/or a list of the assets that may be (e.g., are being) streamed to the receiving entity. In an example of a selection feedback message type (e.g., GPCCSelectionMessageFeedback message type), the client may use the selection feedback message to request the set of assets to be streamed by the sending entity to the receiving entity. In an example of a change view feedback message (e.g., GPCCViewChangeFeedback message), the client may use the view change feedback message to send an indication of the user's current viewing space to the server.

A group message (e.g., the GPCCAssetGroupMessage message) may be used to send G-PCC encoded content via MMT. A group message (e.g., the GPCCAssetGroupMessage message) may provide the client with a list of G-PCC data type assets available at the server and/or may inform the client about which of the assets may be (e.g., are currently being) streamed to the receiving entity. The client may request (e.g., from the list) a unique sub-set of the G-PCC data type assets. The request may be made, for example, using the GPCCSelectionFeedback message.

The client may (e.g., for view-dependent delivery of G-PCC contents through MMT) use the GPCCViewChangeFeedback message, for example, to send a current viewing space (e.g., frustum) information to the server. The server may select and deliver to the client the assets corresponding to the viewing space. The GPCCAssetGroupMessage may (e.g., also) be updated and sent to the client. Table 4 provides examples of defined G-PCC application message types.

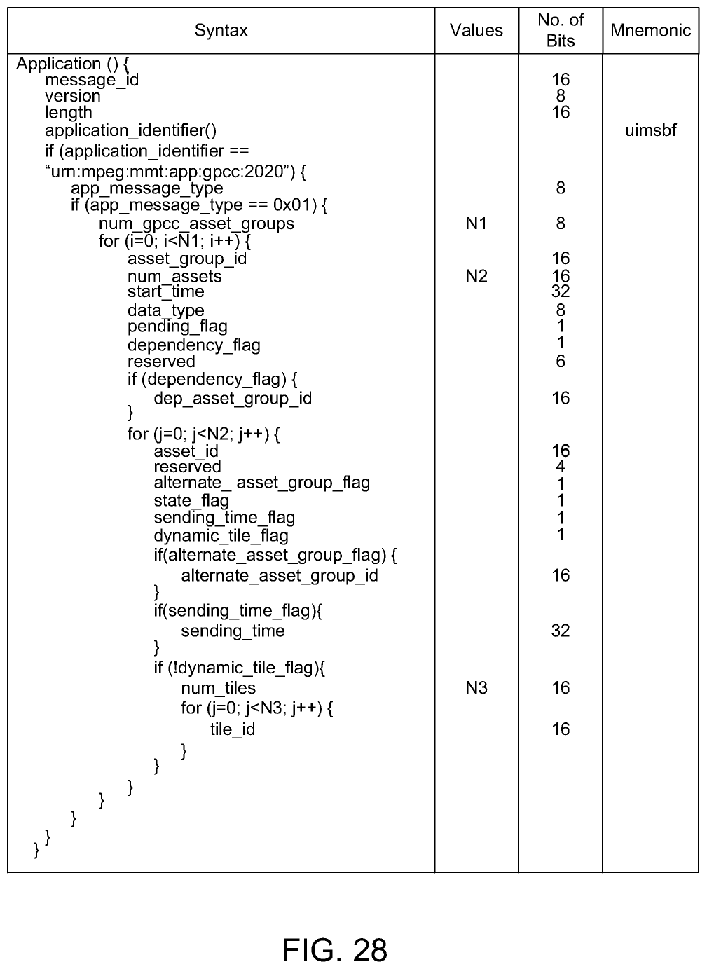

FIG. 28 is a table illustrating an example syntax of a group message, such as a GPCCAssetGroupMessage. Consistent with the table of FIG. 28, the semantics of the GPCCAssetGroupMessage may be as follows. “Message_id” may indicate the identifier of the G-PCC application message. “Version” may indicate the version of the G-PCC application message. “Length” may indicate the length of the G-PCC application message (e.g., in bytes, counting from the beginning of the next field to the last byte of the message). The value of a length field may not be equal to zero (0). An application identifier (e.g., “application_identifier”) may indicate the application identifier as a URN that (e.g., uniquely) identifies the type of application, e.g., to consume the contents of the message. An application message type (e.g., “app_message_type”) may define an application-specific message type (e.g., as provided by example in Table 4). The length of an application message type field may be, for example, 8 bits. A number of G-PCC asset groups (e.g., “num_gpcc_asset_groups”) may indicate the number of G-PCC asset groups. An (e.g., each) asset group may include the assets associated with a G-PCC component. An asset group identifier (e.g., “asset_group_id”) may indicate the identifier of the asset group associated with a G-PCC component. A number of assets (e.g., “num_assets”) may indicate the number of assets within the asset group associated with a G-PCC component. A start time (e.g., “start_time”) may indicate the presentation time of the G-PCC component from which the state of the assets listed in the message may be applicable. A data type (e.g., “data_type”) may indicate the type of G-PCC point cloud data present in the asset group, further described in paragraphs below with respect to FIG. 29. A pending flag (e.g., “pending_flag”) may indicate, for example, whether (e.g., all) the data components are ready for rendering for an asset group. A pending flag set to “1” may indicate that the data is ready. A pending flag set to zero (“0”) may indicate the data is not ready. A dependency flag (e.g., “dependency_flag”) may indicate whether the G-PCC component asset group depends on other G-PCC component asset group data for decoding. A value of zero (“0”) may indicate the G-PCC component asset group data can be decoded independently. A value of one (“1”) may indicate the G-PCC component asset group depends on other G-PCC component asset group data for decoding. A dependent asset group ID (e.g., “dep_asset_group_id”) may indicate the value of the asset group ID upon which the asset group content decoding is dependent. The value may be present, for example, (e.g., only) if/when the dependency_flag is set to 1. For example, a G-PCC attribute component asset group may use the corresponding G-PCC geometry component asset group ID for a dependent asset group ID field. An asset ID (e.g., “asset_id”) may provide the asset identifier of the asset. An alternate asset group flag (e.g., “alternate_asset_group_flag”) may indicate whether the G-PCC component asset has an alternate version. A value of zero (“0”) may indicate the G-PCC component asset does not have an alternate version. A value of one (“1”) may indicate the G-PCC component asset has an alternate version. The value of the alternate group flag field may be set to one (“1”), for example, if/when different encoded versions of the same G-PCC component and/or asset are available in the bitstream. The value of the alternate group flag field may be set to zero (“0”), for example, if/when different encoded versions of the same G-PCC component and/or asset are not available in the bitstream. An alternate asset group ID (e.g., “alternate_asset_group_id”) may indicate the value (e.g., the unique value) of the alternate G-PCC component assets. Different encoded versions of a G-PCC component or asset may represent the same value for an alternate asset group ID field. A state flag (e.g., “state_flag”) may indicate the delivery state of the asset. A state flag set to one (“1”) may indicate that the sending entity is actively sending the asset to the receiving entity. A state flag set to zero (“0”) may indicate that the sending entity is not actively sending the asset to the receiving entity. A sending time flag (e.g., “sending_time_flag”) may indicate the presence of a sending time (e.g., sending_time) for the first MMTP packet including the first MPU of the asset stream. The default value may be, for example, zero (“0”). A sending time (e.g., “sending_time”) may indicate the sending time for the first MMTP packet including the first MPU of the asset stream. A client (e.g., using the sending time information) may prepare a new packet processing pipeline for the new asset stream. A dynamic tile flag (e.g., “dynamic_tile_flag”) may indicate whether the number of tiles and/or tile identifiers may dynamically change in the asset. A value of zero (“0”) may indicate the number of tiles and tile identifiers in the asset do not change throughout the bitstream and/or that the number of tiles (e.g., “num_tiles”) and tile ID (e.g., “tile_id”) are signaled. A value of one (“1”) may indicate the number of tiles and tile identifiers may change in the asset. A value of one (“1”) may indicate the tile IDs present in a tile track are changing dynamically with time in the bitstream. A number of tiles (e.g., “num_tiles”) may indicate the number of tiles carried in the asset. A tile ID (e.g., “tile_id”) may indicate an (e.g., a unique) identifier for a particular tile in the tile inventory. A tile ID (e.g., “tile_id”) may represent a (e.g., one of the) tile id values present in the tile inventory, for example, if/when the dynamic tile flag (e.g., “dynamic_tile_flag”) is set to a value of zero (“0”).

FIG. 29 is a table illustrating an example of G-PCC data type values as may be used in the Data_type field. As shown in FIG. 24, the values for the Data_type field may indicate all G-PCC component data, geometry data, attribute data, SPS, GPS, APS, and tile inventory data, or 3D spatial region timed metadata information.

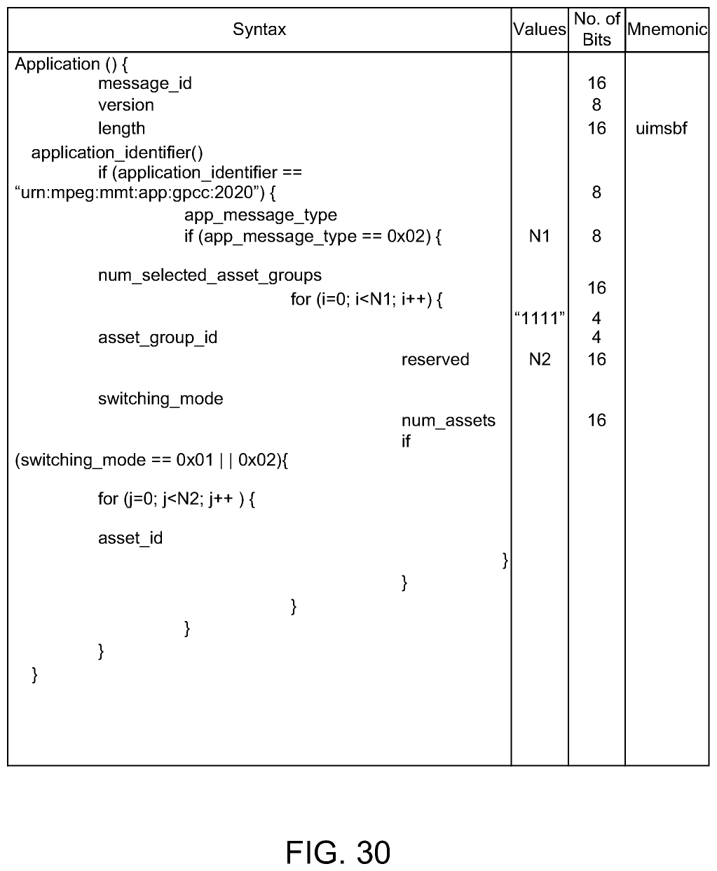

FIG. 30 is a table illustrating an example syntax of a GPCC selection feedback message (e.g., “GPCCSelectionFeedback”). Consistent with the table of FIG. 30, the semantics of the GPCCSelectionFeedback message may be as follows. A message ID (e.g., “message_id”) may indicate the identifier of the G-PCC application message. A version (e.g., “version”) may indicate the version of the G-PCC application message. A length (e.g., “length”) may indicate the length of the G-PCC application message (e.g., in bytes, counting from the beginning of the next field to the last byte of the message). The value of a length field may not be equal to 0. An application identifier (e.g., “application_identifier”) may indicate the application identifier as a URN that (e.g., uniquely) identifies the type of application, e.g., to consume the contents of the message. An application message type (e.g., “app_message_type”) may define an application-specific message type (e.g., described substantially in paragraphs above with respect to FIG. 27). The length of an application message type field may be, for example, 8 bits. A number of selected asset groups (e.g., “num_selected_asset_groups”) may indicate the number of asset groups for which there is an associated state change request by the receiving entity. An asset group ID (e.g., “asset_group_id”) may indicate the identifier of the asset group associated with G-PCC content. A switching mode (e.g., “switching_mode”) may indicate the switching mode used for the selection of assets (e.g., as requested by the receiving entity). A number of assets (e.g., “num_assets”) may indicate the number of assets signaled for a state change (e.g., according to the switching mode specified). An asset ID (e.g., “asset_id”) may indicate the identifier for the asset for the state change (e.g., according to the switching mode specified).

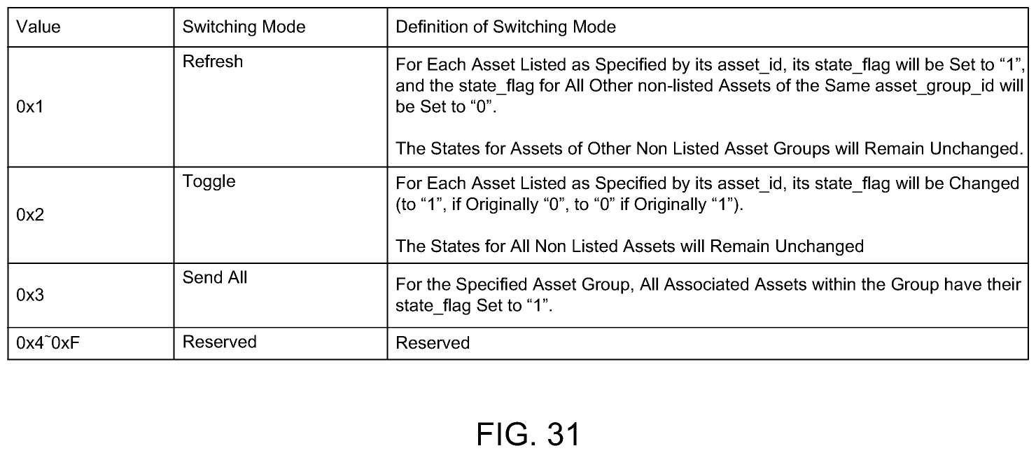

FIG. 31 is a table providing definitions of the switching_mode field. As shown in FIG. 31, the “switching_mode” field may indicate the switching mode used for the selection of assets. For example, if the switching mode is set to refresh, for each asset listed in the GPCCSelectionMessageFeedback, the State_flag of each asset will be set to ‘1’ while the State_flag of all assets not listed in the GPCCSelectionMessageFeedback will be set to ‘0’. If the switching mode is set to toggle, for each asset listed in the GPCCSelectionMessageFeedback, the State_flag of each asset will be change, e.g., to ‘1’ if originally ‘0’, and to ‘0’ if originally ‘1’, while the State_flag of all assets not listed in the GPCCSelectionMessageFeedback will not be changed. If the switching mode is set to send all, for all assets of an asset group specified in the GPCCSelectionMessageFeedback, the State_flag of each asset will be set to ‘1’.

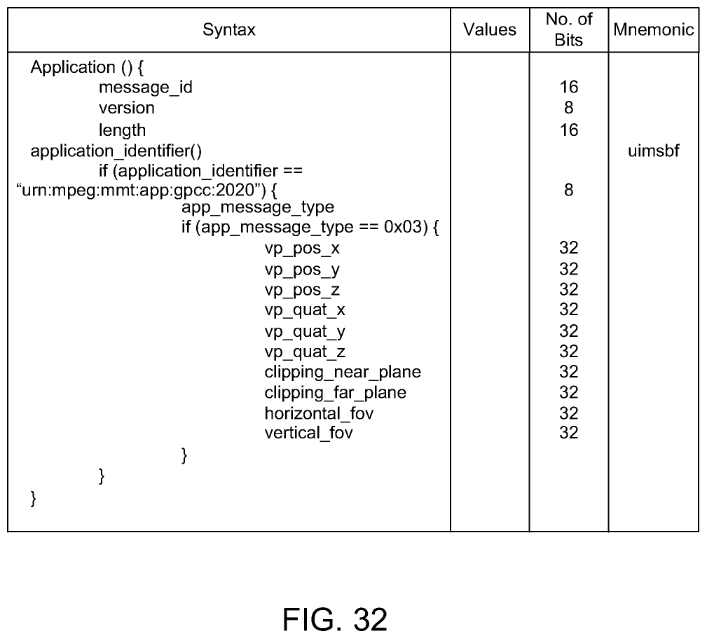

FIG. 32 is a table illustrating an example syntax of a G-PCC view change feedback message (e.g., “GPCCViewChangeFeedback”). Consistent with the table of FIG. 32, the semantics of the GPCCViewChangeFeedback message may be as follows. A message ID (e.g., “message_id”) may indicate the identifier of the G-PCC application message. Version may indicate the version of the G-PCC application message. A length may indicate the length of the G-PCC application message (e.g., in bytes, counting from the beginning of the next field to the last byte of the message). The value of a length field may not be equal to 0. An application identifier (e.g., “application_identifier”) may indicate the application identifier as a URN that (e.g., uniquely) identifies the type of application, e.g., to consume the contents of the message. An application message type (e.g., “app_message_type”) may define an application-specific message type (e.g., as provided by example in Table 4). The length of an application message type field may be, for example, 8 bits. Viewport position coordinates (e.g., vp_pos_x, vp_pos_y, vp_pos_z) may indicate the x, y and z coordinates of the position of a viewport in meters in a global reference coordinate system. The values may be, for example, in units of 2⁻¹⁶ meters. Viewport rotation (e.g., vp quat x, vp quat y, vp quat z) may indicate the x, y, and z components of the rotation of the viewport region (e.g., using the quaternion representation). The values may be, for example, floating-point values in the range of −1 to 1, inclusive. The values may specify the x, y and z components (e.g., qX, qY and qZ) for the rotations that are applied to convert the global coordinate axes to the local coordinate axes of a camera (e.g., using the quaternion representation). The fourth component of the quaternion qW may be calculated, for example, in accordance with Eq. 1, described substantially in paragraphs above. The point (w, x, y, z) may represent a rotation around the axis directed by the vector (x, y, z) by an angle determined in accordance with Eq. 2, also described substantially in paragraphs above.

Clipping in a near plane (e.g., clipping_near_plane) and clipping in a far plane (e.g., clipping_far_plane) may indicate the near and far depths or distances, for example, based on the near and far clipping planes of the viewport (e.g., in meters).

A horizontal field of view (FOV) (e.g., horizontal_fov) may specify the longitude range corresponding to the horizontal size of the viewport region (e.g., in units of radians). The value may be in the range of 0 to 2π.

A vertical FOV (e.g., vertical_fov) may specify the latitude range corresponding to the vertical size of the viewport region (e.g., in units of radians). The value may be in the range of 0 to π.

Streaming client behavior may be provided (e.g., defined or configured). An MMT client may be guided, for example, by information provided in application-specific signaling messages. An example of client behavior is provided for streaming geometry-based point cloud compression content (e.g., using an example of MMT signaling disclosed herein).

An MMT may sending entity may send a “GPCCAssetGroupMessage” application message to interested clients. The receiving client may parse the “GPCCAssetGroupMessage” application message and identify the G-PCC media assets present at the MMT content sending entity. The streaming client may check for an “application_identifier” field in the “GPCCAssetGroupMessage” application message (e.g., set to “urn:mpeg:mmt:app:gpcc:2020”), for example, to identify the available G-PCC media content. The G-PCC assets (e.g., all the G-PCC assets) available in the G-PCC point cloud content may be identified, for example, by checking the asset_ids present in the “GPCCAssetGroupMessage” application message. The client may choose (e.g., select) the asset_ids to be streamed, for example, based on the user current viewport. The MMT client may send a “GPCCSelectionFeedback” application message to the sending entity requesting the interested G-PCC assets from the list of available G-PCC assets. The MMT sending entity may form the MMTP packets with MTPs. The MMT sending entity may send the MTTP packets to clients. The MMT client may receive the MMTP packets. The MMT client may depacketize the MPUs or the MFUs. The MPUs/MFUs may include the timed or non-timed G-PCC media content.

The G-PCC asset data may represent the initialization information (e.g., SPS, GPS, APS, and/or tile inventory), for example, if/when the MMT client receives the MMTP packets with an asset group “data_type” set to “3.” The G-PCC asset data may represent the 3D spatial region timed meta-data information, for example, if/when the MMT client receives the MMTP packets with an asset group “data_type” set to “4.” The G-PCC asset information may be used for partial access of G-PCC data.

The MMT client may select the G-PCC assets based on the user viewport and the corresponding 3D spatial region(s). The MMT client may send a “GPCCSelectionFeedback” application message to the sending entity requesting the G-PCC assets of interest. The MMT client may request a different set of G-PCC assets (e.g., using the “GPCCSelectionFeedback” application message), for example, if/when the user viewport changes.

The MMT client may send the “GPCCViewChangeFeedback” message to the sending entity (e.g., to signal the user's current viewport), for example, if/when the user viewport changes. The MMT sending entity (e.g., upon receiving the message from the MMT client) may select the G-PCC assets (e.g., based on the user's new viewport information). The MMT sending entity may send the “GPCCAssetGroupMessage” application message to the MMT client with the corresponding G-PCC Assets. The MMT sending entity may stream the G-PCC assets data as MMTP packets.

The MMT client may start receiving the MMTP packets for (e.g., all) the requested G-PCC assets. The MMT client may extract the MPUs and MFUs from the MMTP payload. The MPUs and MFUs may include the media samples (e.g., directly) or the media segments.

The MMT client may start parsing the media segment container (e.g., ISOBMFF) to extract the elementary stream information, structure the G-PCC bitstream, and pass the bitstream to the G-PCC decoder. The elementary stream data may be extracted and structured and the bitstream may be passed to the G-PCC decoder, for example, if/when the MMTP payload includes the G-PCC media samples.

Systems, methods, and apparatuses have been described herein for MPEG media transport (MMT) streaming of geometry-based point clouds (G-PCC). G-PCC encoded content may be delivered over networks using MMT. G-PCC data may be encapsulated for MMT streaming. MMT signaling messages may support the delivery of G-PCC data over MMT. A (e.g., each) track may be encapsulated into a separate asset, which may be packetized into MMTP packets, for example, if/when the G-PCC components inside the international organization for standardization base media file format (ISOBMFF) are signaled using multiple tracks. A G-PCC defined application message may enable a server and a client to identify a group of multiple assets for a G-PCC component.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-18. (canceled)

19. A method implemented in a receiving device for streaming Motion Picture Experts Group (MPEG) Media Transport Protocol (MMTP) media content, the method comprising:
receiving, from a sending device, an asset group message including asset descriptor data describing one or more asset groups that are available to be streamed, wherein the asset descriptor data includes a field indicating respective data types associated with each asset of the one or more asset groups;
sending, to the sending device, an asset selection message including a request for at least a subset of assets of the one or more asset groups that are available to be streamed, wherein the asset selection message includes at least one identifier associated with at least one of the requested subset of assets;
receiving, from the sending device, in response to the asset selection message, one or more MMTP packets; and
processing the one or more MMTP packets to recover at least a portion of the requested subset of assets of the one or more asset groups.

20. The method of claim 19, further comprising sending, to the sending device, a viewport change message including an indication of a current viewport of the receiving device; and receiving another asset group message that includes updated asset descriptor data describing one or more asset groups that are available to be streamed based on the current viewport of the receiving device.

21. The method of claim 19, wherein the requested at least the subset of assets of the one or more asset groups that are available to be streamed are selected by the receiving device based on a current viewport of the receiving device.

22. The method of claim 19, wherein the asset descriptor data includes a unique identifier associated with each of the assets of the one or more asset groups.

23. The method of claim 19, wherein the sent asset selection message includes information identifying an application intended to consume the requested subset of assets.

24. The method of claim 19, wherein the asset descriptor data describing the one or more asset groups that are available to be streamed describes volumetric video-based coding (V3C) data.

25. The method of claim 24, wherein the respective data types associated with each asset of the one or more asset groups are one of atlas component data, occupancy component data, geometry component data, attribute component data, dynamic volumetric timed-metadata information, or viewport timed-metadata information.

26. The method of claim 19, wherein the asset descriptor data describing the one or more asset groups that are available to be streamed describes geometry-based point cloud compression (G-PCC) data.

27. The method of claim 26, wherein the respective data types associated with each asset of the one or more asset groups are one of geometry data; attribute data; attribute parameter set data; sequence parameter set data; geometry parameter set data; tile inventory data; frame boundary market data; default data; or three-dimensional spatial region timed metadata information.

28. The method of claim 19, wherein the asset group message includes information indicating one or more of: a dependency of an asset upon another asset for decoding; an indication of the another asset upon which the asset is dependent; whether the asset has an alternate version; and an identification of the alternate version of the asset.

29. A receiving device configured to stream Motion Picture Experts Group (MPEG) Media Transport Protocol (MMTP) media content, the receiving device comprising:
a processor; and
a communications interface;
the processor and the communication interface configured to receive, from a sending device, an asset group message including asset descriptor data describing one or more asset groups that are available to be streamed, wherein the asset descriptor data includes a field indicating respective data types associated with each asset of the one or more asset groups;
the processor and the communication interface configured to send, to the sending device, an asset selection message including a request for at least a subset of assets of the one or more asset groups that are available to be streamed, wherein the asset selection message includes at least one identifier associated with at least one of the requested subset of assets;
the processor and the communication interface configured to receive, from the sending device, in response to the asset selection message, one or more MMTP packets; and
the processor to process the one or more MMTP packets to recover at least a portion of the requested subset of assets of the one or more asset groups.

30. The receiving device of claim 29, the processor and the communication interface configured to send, to the sending device, a viewport change message including an indication of a current viewport of the receiving device; and
receiving another asset group message that includes updated asset descriptor data describing one or more asset groups that are available to be streamed based on the current viewport of the receiving device.

31. The receiving device of claim 29, wherein the requested at least the subset of assets of the one or more asset groups that are available to be streamed are selected by the receiving device based on a current viewport of the receiving device.

32. The receiving device of claim 29, wherein the asset descriptor data includes a unique identifier associated with each of the assets of the one or more asset groups.

33. The receiving device of claim 29, wherein the sent asset selection message includes information identifying an application intended to consume the requested subset of assets.

34. The receiving device of claim 29, wherein the asset descriptor data describing the one or more asset groups that are available to be streamed describes volumetric video-based coding (V3C) data.

35. The receiving device of claim 34, wherein the respective data types associated with each asset of the one or more asset groups are one of atlas component data, occupancy component data, geometry component data, attribute component data, dynamic volumetric timed-metadata information, or viewport timed-metadata information.

36. The receiving device of claim 29, wherein the asset descriptor data describing the one or more asset groups that are available to be streamed describes geometry-based point cloud compression (G-PCC) data.

37. The receiving device of claim 36, wherein the respective data types associated with each asset of the one or more asset groups are one of geometry data; attribute data; attribute parameter set data; sequence parameter set data; geometry parameter set data; tile inventory data; frame boundary market data; default data; or three-dimensional spatial region timed metadata information.

38. The receiving device of claim 29, wherein the asset group message includes information indicating one or more of: a dependency of an asset upon another asset for decoding; an indication of the another asset upon which the asset is dependent; whether the asset has an alternate version; and an identification of the alternate version of the asset.
